(19) United States
(12) Patent Application Publication
(10) Pub. No.: US 2025/0311025 A1
(43) Pub. Date: Oct. 2, 2025

(54) Methods and Apparatus Supporting User Equipment (UE) Access to a Core Network Via a Wireless Local Area Network (WLAN) and Facilitating Transfer of Application Data via the Core Network

(71) Applicant: Charter Communications Operating, LLC, St. Louis, MO (US)

(72) Inventors: Yildirim Sahin, Englewood, CO (US); Paul L. Russell, JR., Lawrence, NJ (US); Umamaheswar Achari Kakinada, Greenwood Village, CO (US); Imtiyaz Shaikh, Irving, TX (US)

(21) Appl. No.: 18/882,645

(22) Filed: Sep. 11, 2024

Related U.S. Application Data
(60) Provisional application No. 63/573,449, filed on Apr. 2, 2024.

(51) Int. Cl. H04W 76/11; H04W 12/033; H04W 12/069; H04W 76/16

(52) U.S. Cl. CPC H04W 76/11; H04W 12/033; H04W 12/069; H04W 76/16

(57) ABSTRACT

Methods and apparatus for: i) providing a user equipment (UE) access to a core network, e.g., a 3GPP 5G core network, via a wireless local area network access point (WLAN AP) (e.g., a non-integrated non-3GPP access network), without the use of a non-3GPP Interworking Function (N3IWF) or a Trusted non-3GPPP Gateway Function (TNGF) and ii) allowing the transfer of application data via the core network are described. The transfer of application data is, i.e., in both directions, e.g. UE to User Plane Function (UPF) to data network (DN) and DN to UPF to UE. The access obtained by the UE does not require the presence of a 3GPP access network, e.g., a 3GPP radio access network (RAN) such as a gNB.

### RELATED APPLICATIONS

The present application claims the benefit of U.S. Provisional Patent Application Ser. No. 63/573,449 which was filed on Apr. 2, 2024 and which is hereby expressly incorporated by reference in its entirety.

### FIELD

The present invention is directed to wireless communications, and more particularly, to methods and apparatus for supporting user equipment (UE) access to a core network, e.g. a 3GPP 5G core network, via a wireless local area network access network (WLAN), e.g., a non-integrated non-3GPP access network, and facilitating the efficient transfer of application data via the core network.

### BACKGROUND

Numerous references set forth standards and/or provide information relating to wireless communications. References which are hereby expressly incorporated by reference in their entirety include the references listed below.
[1] 3GPP TR 21.905: “Vocabulary for 3GPP Specifications” v17.1.0 (12-2021)
[2] 3GPP TS 23.501: “System Architecture for the 5G System (5GS); Stage 2” v18.4.0 (12-2023)
[3] 3GPP TS 23.502: “Procedures for the 5G System; Stage 2” v18.4.0 (12-2023)
[4] 3GPP TS 23.503: “Policies and Charging control framework for the 5G System; Stage 2” v18.4.0 (12-2023)
[5] IETF RFC 3711: “The Secure Real-time Transport Protocol (SRTP)”, March 2004.
[6] IETF RFC 6904: “Encryption of Header Extensions in the Secure Real-time Transport Protocol (SRTP)”, April 2013
[7] IETF RFC 9335: “Completely Encrypting RTP Header Extensions and Contributing Sources”, January 2023
[8] IETF draft-ietf-avtcore-rtp-over-quic: “RTP over QUIC (RoQ)”, Oct. 23, 2023.
[9] IETF draft-ietf-moq-transport: “Media over QUIC Transport”, Oct. 23, 2023
[10] IETF experimental draft-ietf-avtext-framemarking: “Video Frame Marking RTP Header Extension”, Jul. 26, 2023.
[11] IETF RFC 9000: “QUIC: A UDP-Based Multiplexed and Secure Transport”, May 2021.
[12] IETF RFC 9330: “Low Latency, Low Loss, and Scalable Throughput (L4S) Internet Service: Architecture, January 2023
[13] IETF RFC 9331: “The Explicit Congestion Notification (ECN) Protocol for Low Latency, Low Loss, and Scalable Throughput (L4S)”, January 2023.
[14] IETF draft-ietf-tsvwg-ecn-encap-guidelines-22: “Guidelines for Adding Congestion Notification to Protocols that Encapsulate IP”, Dec. 5, 2023.
[15] 3GPP TS 33.402 “Technical Specification Group Services and System Aspects; 3GPP System Architecture Evolution (SAE); Security aspects of non-3GPP accesses”, Release 18, v18.0.0 March 2023
[16] 3GPP TR 23.700-54 V0.2.0 3GPP Technical Specification Group Services and System Aspects; Study on Multi-Access (DualSteer and ATSSS_Ph4), Release 19, March 2024
[17] IETF RFC 8684, titled: TCP Extensions for Multipath Operation with Multiple Addresses, March 2020
[18] RFC 9001 Using TLS to Secure QUIC, May 2021
[19] RFC 9002 QUIC Loss Detection and Congestion Control, May 2021
[20] RFC 9221 An Unreliable Datagram Extension to QUIC, March 2022

In 3GPP R18 of TS23.501 clause 4.2.8.2 non-3GPP access Architecture diagrams are illustrated. Drawing 100 of FIG. 1 shows how a UE connects to the 5GC network via a Non-3GPP Interworking Function (N3IWF). Drawing 200 of FIG. 2 shows how a UE connects to the 5GC network via a Trusted Non-3GPP Gateway Function (TNGF).

Drawing 100 of FIG. 1, which corresponds to FIG. 4.2.8.2.1-1 of TS23.501 illustrates a non-roaming architecture for 5G Core Network with untrusted non-3GPP access. The system of FIG. 1 includes user equipment (UE) 102, an untrusted non-3GPP access network 104, a non-3GPP Interworking Function (N3IWF) 105, a user plane function (UPF) 106, a session management function (SMF) 108, a 3GPP access network 118, an access and mobility management function (AMF) 120 and a data network 122 coupled together as shown. UE 102 is coupled to untrusted non-3GPP access network 104 via Y1 interface connection 150. UE 102 has a N1 connection 152 with AMF 120, via untrusted non-3GPP access network 104 and N3IWF 105. UE 102 has a NWu connection 154 with N3IWF 105 via untrusted non-3GPP access network 104. UE 102 has a wireless connection 160 with 3GPP access network 118. UE 102 has a N1 connection 162 with AMF 120 via 3GPP access network 118.

N3IWF 105 has a N3connection 166 with UPF 106 and a N2 connection 158 with AMF 120. Untrusted non-3GPP access network 104 has a Y2 connection 156 with N3IWF 105. 3GPP access network 118 has a N2 connection 164 with AMF 120 and a N3connection 168 with UPF 106. AMF 120 has a N11 connection 170 with SMF 108. SMF 108 has a N4 connection 172 with UPF 106. UPF 106 has a N6 connection 174 with data network 122.

In the example of FIG. 1, the 3GPP access network 118, AMF 120, N3IWF 105, SMF 108 and UPF 106 are part of the Home Public Land Mobile Network (HPLMN) 198, and untrusted Non-3GPP access network 104 is part of non-3GPP networks 199.

Drawing 200 of FIG. 2, which corresponds to FIG. 4.2.8.2.1-2 of TS23.501 illustrates a non-roaming architecture for 5G Core Network with trusted non-3GPP access. The system of FIG. 2 includes user equipment (UE) 202, a trusted non-3GPP access network (TNAN) 204, a user plane function (UPF) 206, a session management function (SMF) 208, a 3GPP access network 218, an access and mobility management function (AMF) 220 and a data network 222 coupled together as shown. TNAN 104 includes a trusted non-3GPP access point (TNAP) 205 and a trusted non-3GPP gateway function (TNGF) 207 coupled together.

UE 202 is coupled to TNAP 205 of TNAP 104 via Yt interface connection 250. UE 202 has a N1 connection 252 with AMF 220, via TNAP 105 and TNGF 207 of TNAP 204. UE 202 has a NWt connection 254 with TNGF 207 via TNAP 205. UE 202 has a wireless connection 260 with 3GPP access network 218. UE 202 has a N1 connection 262 with AMF 220.

TNAP has a Ta connection 257 with TNGF 207. TNGF has a Tn loop connection 259. TNGF 207 has a N3connection 266 with UPF 206 and a N2 connection 258 with AMF 220. 3GPP access network 218 has a N2 connection 264 with AMF 220 and a N3 connection 268 with UPF 206. AMF 220 has a N11 connection 270 with SMF 208. SMF 208 has a N4 connection 272 with UPF 206. UPF 206 has a N6 connection 274 with data network 222.

In the example of FIG. 2, the 3GPP access network 218, AMF 220, TNAN 204, SMF 208 and UPF 206 are part of the Home Public Land Mobile Network (HPLMN) 298.

For R19, 3GPP has started a study on simplifying the non-3GPP access ATSSS (Access Traffic Steering, Switching & Splitting) Architecture. Drawing 20 of FIG. 3, which corresponds to 3GPP TS 23.700 54 v0.2.0, FIG. 6.2.8.1.1.1, illustrates a sample architecture for simplified ATSSS over non-3GPP based on direct MPQUIC connection between UE 22 and UPF 26. The exemplary architecture of FIG. 3 includes UE 22, non-3GPP access network 24, UPF 26, SMF 28, PCF 36, 3GPP access network 38, AMF 42 and data network 42 coupled together as shown. UE 22 is coupled to 3GPP access network 38 via connection 60. 3GPP access network 38 is coupled to UPF 26 via connection 68. N1 interface connection 51 couples UE 22 to AMF 42. 3GPP access network 38 is coupled to AMF 42 via N2 interface connection 64. UE 22 is coupled to UPF 26 via Nx interface connection 50 and non-3GPP access network 24. N1 connection 51 couples UE 22 to AMF 42 via 3GPP access network 38. UE 22 is coupled to 3GPP access network 38 via connection 60. 3GPP access network 38 is coupled to UPF 26 via connection 68. UPF 26 is coupled to data network 42 via connection 74. AMF 42 is coupled to SMF 28 via N1 interface connection 70. SMF 28 is coupled to PCF 36 via N7 interface connection 76. SMF 28 is coupled to UPF 26 via N4 interface connection 72.

This simplified ATSSS architecture of FIG. 3, which has been proposed, has the following basic principles and assumptions:

N3IWF/TNGF is not used when accessing over non-3GPP access 24.

UE 22 has no N1 (NAS) signaling connection with the 5G Core (5GC) network over non-3GPP access 24.

The UPF (PSA) 26 has at least one transport address (i.e. an IP address and a port number) that is reachable via the Internet over the non-3GPP access (e.g., WLAN).

The solution only supports Multipath QUIC (MPQUIC) Steering Functionality. Access Traffic Steering, Switching & Splitting Lower Layer (ATSSS-LL) and Multipath TCP (MPTCP) are not supported.

TR23.700-54 clause 5.2.2, in discussing what is identified as Key Issue #2.2: Simplified ATSSS architecture over non-3GPP access, indicates that the current ATSSS architecture requires that non-3GPP access is provided via the trusted or untrusted non-3GPP access procedures. This means that to enable ATSSS either a TNGF or an N3IWF is deployed. A key issue that is to be addressed is whether and how to define a functional architecture and procedures for steering, switching, and splitting of traffic not utilising the TNGF/N3IWF as specified in Rel-18 and earlier releases (TS 23.501) to simplify the network operation over non-3GPP access, without compromising the security of the 5G network.

In particular, key issues which remain to be studied and addressed include:
1) Protocol stack simplification
   Whether and how to eliminate the NAS signaling connection over non-3GPP access, or not.
   Whether and how to eliminate IPSec tunnel encapsulation on the user plane only or both on the control plane and the user plane, in order to simplify the UE protocol stack and reduce the user plane overhead.
2) “non-3GPP access without 5G NAS over non-3GPP”.
   Whether and how to support splitting, switching, steering between 3GPP access and “non-3GPP access without 5G NAS over non-3GPP”.
   Whether and how to enhance registration and security aspects for supporting “non-3GPP access without 5G NAS over non-3GPP”. This may include studying also whether registration would be used over non-3GPP access.

Drawing 300 of FIG. 4, which corresponds to TW-23.501 FIG. 4.2.10-1, illustrates Non-roaming and Roaming with Local Breakout architecture for ATSSS support. Drawing 400 of FIG. 5, which corresponds to TW-23.501 FIG. 4.2.10-2, illustrates Roaming with Home-routed architecture for ATSSS support for a scenario in which the UE is registered to the same VPLMN. Drawing 500 of FIG. 6, which corresponds to TS-23.501 FIG. 4.2.10-3, illustrates Roaming with Home-routed architecture for ATSSS support, for a scenario in which UE is registered to different PLMNs.

The system of FIG. 4, which illustrates non-roaming and roaming with local breakout architecture for ATSSS support, includes user equipment (UE) 302, a non-3GPP access network 304, a user plane function (UPF) 306, a session management function (SMF) 308, a policy control function (PCF) 316, a 3GPP access network 318, an access and mobility management function (AMF) 320 and a data network (DN) 322 coupled together as shown. UE 302 is coupled to non-3GPP access network 304 via Y1 interface connection 350. UE 302 has a N1 connection 352 with AMF 320, via non-3GPP access network 304. UE 302 has a wireless connection 360 with 3GPP access network 318. UE 302 has a N1 connection 362 with AMF 320.

3GPP access network 318 has a N2 connection 364 with AMF 320 and a N3connection 368 with UPF 306. AMF 320 has a N11 connection 370 with SMF 308. SMF 308 has a N4 connection 372 with UPF 306 and a N7 connection 376 with PCF 316. UPF 306 has a N6 connection 374 with data network 322.

UE 302 includes MPTCP functionality 380, MPQUIC functionality 381, ATSSS-LL functionality 382 and Performance Management Function (PMF) 383. UPF 306 includes MPTCP Proxy functionality 390, MPQUIC Proxy functionality 391, ATSSS-LL functionality 392 and PMF 393.

The system of FIG. 5, which illustrates roaming with home-routed architecture for ATSSS support for a scenario with UE registered to the same VPLMN, includes user equipment (UE) 402, a non-3GPP access network 404, a 3GPP access network 418, an AMF 420, a V-SMF 409, a V-UPF 405, a H-SMF 408, a H-PCF 416, a H-UPF 406 and a data network 422 coupled together as shown. UE 402 is coupled to non-3GPP access network 404 via Y1 interface connection 450. UE 402 has a N1 connection 452 with AMF 420, via non-3GPP access network 404. UE 402 has a wireless connection 460 with 3GPP access network 418. UE 402 has a N1 connection 462 with AMF 420 via 3GPP access network 418.

3GPP access network 418 has a N2 connection 464 with AMF 420 and a N3connection 468 with V-UPF 405. AMF 420 has a N11 connection 470 with V-SMF 409. V-SMF 409 has a N16 connection 471 with H-SMF 408 and a N4 connection 479 with V-UPF 405.

V-SMF 409 has a N16 connection 471 with H-SMF 408. H-SMF 408 has a N7 connection 476 with H-PCF 416. H-SMF 408 has a N4 connection 472 with H-UPF 406. V-UPF 405 has first and second N9 connections (469, 467) with H-UPF 406. H-UPF 406 has a N6 connection 474 with data network 422.

UE 402 includes MPTCP functionality 480, MPQUIC functionality 481, ATSSS-LL functionality 482 and PMF 483. H-UPF 406 includes MPTCP Proxy functionality 490, MPQUIC Proxy functionality 491, ATSSS-LL functionality 492 and PMF 493.

In the example of FIG. 5, the 3GPP access network 418, the non-3GPP access network 404, AMF 120, V-SMF 409 and V-UPF 305 are part of the Visitor Public Land Mobile Network (VPLMN) 499, while H-SMF 408, H-PCF 416, and H-UPF 406 are part of the HPLMN 498.

The system of FIG. 6, which illustrates Roaming with Home-routed architecture for ATSSS support for a scenario with UE registered to different PLMNs, includes user equipment (UE) 502, a non-3GPP access network 504, a 3GPP access network 518, an AMF 520, a V-SMF 509, a V-UPF 505, a H-SMF 508, a H-PCF 516, a H-UPF 506, AMF 521 and a data network 522 coupled together as shown. UE 502 is coupled to non-3GPP access network 504 via Y1 interface connection 550. UE 502 has a N1 connection 552 with AMF 521, via non-3GPP access network 504. UE 502 has a wireless connection 560 with 3GPP access network 518. UE 502 has a N1 connection 562 with AMF 520 via 3GPP access network 518.

3GPP access network 518 has a N2 connection 564 with AMF 520 and a N3connection 568 with V-UPF 505. AMF 520 has a N11 connection 570 with V-SMF 509. V-SMF 509 has a N16 connection 575 with H-SMF 508 has a N4 connection 573 with V-UPF 505.

V-SMF 509 has a N16 connection 575 with H-SMF 508. H-SMF 508 has a N7 connection 576 with H-PCF 516. H-SMF 508 has a N4 connection 572 with H-UPF 506. V-UPF 505 has an N9 connection 569 with H-UPF 506. H-UPF 506 has a N6 connection 574 with data network 522. H-SMF 508 has a N11 connection 571 with AMF 521.

UE 502 includes MPTCP functionality 580, MPQUIC functionality 581, ATSSS-LL functionality 582 and PMF 583. H-UPF 506 includes MPTCP Proxy functionality 590, MPQUIC Proxy functionality 591, ATSSS-LL functionality 592 and PMF 593.

In the example of FIG. 6, the 3GPP access network 518, AMF 520, V-SMF 509 and V-V-UPF 505 are part of the Visitor Public Land Mobile Network (VPLMN) 599, while non-GPP access network 504, AMF 521, H-SMF 508, H-PCF 516, and H-UPF 506 are part of the HPLMN 598.

FIG. 7 is a drawing 600, which corresponds to FIG. 5.32.6.1-1, illustrating R18 Steering Functionalities in an example UE model. Drawing 600 includes non-3GPP access 602, 3GPP access 604, a higher layer 606, a middle layer 608, e.g., IP stack, a lower layer 610, and ATSSS rules 616. Drawing 600 further includes non-MPTCP and non MPQUIC flows 664, e.g., UDP, TCP and Ethernet flows, MPTCP flows 666, e.g., TCP flows from apps allowed to use MPTCP, MPQUIC flows 668, e.g., UDP flows from apps allowed to use MPQUIC. Drawing portion 612 of FIG. 7 illustrates ATSSS-LL. Drawing portion 614 of FIG. 7 illustrates ATSSS-HL. The higher-level 606 includes MPTCP functionality 620 and MPQUIC functionality 624. The lower layer 610 includes ATSSS-LL functionality 640.

The R18 ATSSS capabilities corresponding to FIG. 7 include: i) steering functionality and ii) steering modes. The steering functionality includes: i) higher layer (above IP layer) steering functionality including MPTCP steering functionality 620 and MPQUIC R18 steering functionality 628; and ii) lower level (below IP layer) steering functionality including ATSSS-LL steering functionality 640. The steering modes include: i) an active-standby mode, ii) a smallest delay (non-GBR SDF (non-Guaranteed Bit Rate Service Data Flow)) mode; iii) a load-balancing (non-GBR SDF) mode; iv) a priority-based (non-GBR SDF) mode; and v) a redundant steering mode R18. Note: All 3 steering functions (620, 624, 640) may be supported by the UE and network. That is, applications' traffic may be distributed access the 2 accesses (602, 604) using (TCP and/or UDP flows) and/or ATSSS-LL (e.g., Ethernet flows).

An ATSSS-capable UE that can steer, switch, and split the MAPDU Session traffic across 3GPP and N3GPP accesses (604, 602) is called a “steering functionality”.

An ATSSS-capable UE may support one or more of the following types of steering functionalities: High layer steering functionalities, which operate above the IP layer, and Low-layer steering functionalities, which operate below the IP layer.

In R17 only one high-layer steering functionality was specified, which applies the MPTCP protocol (see IETF RFC 8684, titled: TCP Extensions for Multipath Operation with Multiple Addresses, March 2020) and is called “MPTCP functionality”. This steering functionality 620 can be applied to steer, switch and split the TCP traffic 666 of allocations allowed to use MPTCP. The MPTCP functionality 620 in the UE may communicate with an associated MPTCP Proxy functionality in the UPF, by using the MPTCP protocol over the 3GPP and/or non-3GPP user plane.

In R18 an additional high-layer steering functionality was specified, which applies the QUIC protocol (see IETF RFC 9000/9001/9002/9221) and its multipath extensions (see draft-ietf-quic-multipath) and is called “MPQUIC functionality”. This steering functionality 624 can be applied to steer, switch and split the UDP traffic 668 of applications allowed to use MPQUIC. The MPQUIC functionality 624 in the UE may communicate with an associated MPQUIC proxy functionality in the UPF, by using the QUIC protocol and its multipath extensions over the 3GPP and/or the non3-GPP user plane.

In R17, one type of low-layer steering functionality defined is called “ATSSS Low-Layer functionality” or ATSSS-LL functionality. The ATSSS-LL functionality 640 in the UE does not apply a specific protocol. The ATSSS LL functionality 640 is a data switching function, which decides how to steer, switch and split the uplink traffic across 3GPP and non-3GPP accesses (604, 602), based on the provisioned ATSSS rules 616 and local conditions (e.g., signal loss conditions). This steering functionality 640 can be applied to steer, switch and split all types of traffic, including TCP traffic, UDP traffic, Ethernet traffic, etc. The ATSSS-LL functionality 640 is mandatory for MA PDU Session of type Ethernet. In the network, there shall be in the data path of the MA PDU session one UPF supporting ATSSS-LL.

In view of the above it should be appreciated that there is a need for improved methods and/or apparatus relating to non-3GPP access. In particular there is a need for new methods and apparatus which facilitate a UE to securely access a 5G core network via a non-integrated non-3GPP access network, e.g., a WLAN AP, without the use of non-3GPP Interworking Function (N3IWF) or a Trusted Non-3GPP Gateway Function (TNGF). It would be desirable if at least some of these new methods and apparatus supported MPTCP, MPQUIC and/or ATSSS-LL functionality. It would also be desirable if at least some of these new methods and apparatus facilitated coordination between non-3GPP access procedures and 3GPP access procedures.

### SUMMARY

Methods and apparatus for: i) providing a user equipment (UE) access to a core network, e.g., a 3GPP 5G core network, via a wireless local area network access point (WLAN AP) (e.g., a non-integrated non-3GPP access network), without the use of a non-3GPP Interworking Function (N3IWF) or a Trusted non-3GPP Gateway Function (TNGF) and ii) allowing the transfer of application data via the core network are described. The transfer of application data is, i.e., in both directions, e.g. UE to User Plane Function (UPF) to data network (DN) and DN to UPF to UE. The access obtained by the UE does not require the presence of a 3GPP access network, e.g., a 3GPP radio access network (RAN) such as a gNB.

The UE selects a UPF, which supports non-integrated non-3GPP access, and obtains its IP address. In some embodiments, the UE is provisioned with a FQDN (Fully Qualified Domain Name) that it uses to obtain the IP address of the UPF, via querying a DNS (Domain Name Server). This provisioning is done by the network operator via ANDSP (Access Network Discovery and Selection Policy) or URSP (UE Route Selection Policy) rules or initial configuration of the UE by the operator. By querying the DNS, the IP address of a UPF which supports non-integrated non-3GPP access is obtained.

In at least some embodiments, the UE and UPF are provisioned with security certificates by the operator, which can be, and sometimes are, used to establish a secure QUIC connection between the UE and the UPF of the core network. Thus, in some embodiment an initial connection or connections between the UE and UPF is implemented as QUIC secure connections, using the provisioned certificates (key_share) or using the QUIC CERT (QUIC Certificate). The UPF selects a session management function (SMF) that supports non-integrated non-3GPP access. The secure connection is then used to perform an EAP authentication procedure with the core network (i.e., UE authenticates with 5GC).

The secure connection is used for both UE authentication with the core network and transferring applicable information (e.g., PDU Session ID, S-NSSAI, etc.) for PDU Session establishment. One or more PDU sessions are established using secure connection(s), e.g., QUIC connections.

Once a PDU session is established data sessions can and do proceed, e.g. with the UE sending application data to the UPF which sends the data to the data network (DN), and with the DN sending data to the UPF which sends the data to the UE, e.g., with data being communicated over the secure connection established between the UE and UPF which traverses the non-integrated non-3GPP access network.

Subsequently, the UE may, and sometimes does, perform a 3GPP registration (e.g., 5G registration over 3GPP access) and PDU session establishment over a 3GPP access network, e.g. a RAN gNB. The UE, which includes ATSSS capabilities, may split data being communicated between the path including the non-integrated non-3GPP access network and the path including the 3GPP access network.

Numerous additional features, benefits and embodiments are discussed in the detailed description which follows.

While various features discussed in the summary are used in some embodiments it should be appreciated that not all features are required or necessary for all embodiments and the mention of features in the summary should in no way be interpreted as implying that the feature is necessary or critical for all embodiments. Numerous additional features and embodiments are discussed in the detailed description which follows. Numerous additional benefits will be discussed in the detailed description which follows.

### BRIEF DESCRIPTION OF THE FIGURES

FIG. 1 illustrates a prior art non-roaming architecture for 5G Core Network with untrusted non-3GPP access.

FIG. 2 illustrates a prior art non-roaming architecture for 5G Core Network with trusted non-3GPP access.

FIG. 3 illustrates a prior art sample architecture for simplified Access Traffic Steering, Switching and Splitting (ATSSS) over non-3GPP based on direct MPQUIC connection between UE and UPF.

FIG. 4 illustrates non-roaming and roaming with prior art local breakout architecture for ATSSS support.

FIG. 5 illustrates roaming with prior art Home-routed architecture for ATSSS support for a scenario in which the UE is registered to the same VPLMN.

FIG. 6 illustrates roaming with prior art Home-routed architecture for ATSSS support, for a scenario in which the UE is registered to different PLMNs.

FIG. 7 is a drawing illustrating 3GPP Release 18 (R18) Steering Functionalities in an example UE model.

FIG. 8 illustrates an exemplary communications system in accordance with exemplary embodiments of the present invention.

FIG. 9A is a first part of a first diagram illustrating components, steps and/or signaling used in an exemplary authentication and connection set up procedure for non-integrated non-3GPP (e.g., WLAN) access implemented in accordance with an embodiment of the present invention.

FIG. 9B is a second part of the first diagram illustrating components, steps and/or signaling used in an exemplary authentication and connection set up procedure for non-integrated non-3GPP (e.g., WLAN) access implemented in accordance with an embodiment of the present invention.

FIG. 9 comprises the combination of FIG. 9A and FIG. 9B.

FIG. 10A is a first part of a second diagram, which is more detailed than the FIG. 9 diagram, illustrating components, steps and/or signaling used in an exemplary authentication and connection set up procedure for non-integrated non-3GPP (e.g., WLAN) access implemented in accordance with an embodiment of the present invention.

FIG. 10B is a second part of the second diagram, which is more detailed than the FIG. 9 diagram, illustrating components, steps and/or signaling used in an exemplary authentication and connection set up procedure for non-integrated non-3GPP (e.g., WLAN) access implemented in accordance with an embodiment of the present invention.

FIG. 10C is a third part of the second diagram, which is more detailed than the FIG. 9 diagram, illustrating components, steps and/or signaling used in an exemplary authentication and connection set up procedure for non-integrated non-3GPP (e.g., WLAN) access implemented in accordance with an embodiment of the present invention.

FIG. 10 comprises the combination of FIG. 10A, FIG. 10B and FIG. 10C.

FIG. 11 illustrates an exemplary user equipment (UE), in accordance with the present invention, which can be used as the UE device in either of the FIG. 9 or FIG. 10 embodiments.

FIG. 12 is an exemplary user plane function (UPF), e.g., a PSA UPF, of a core network, e.g., a 5G PLMN core network, in accordance with an exemplary embodiment.

FIG. 13 illustrates an exemplary non-3GPP access network, e.g., a non-integrated non-3GPP access point (AP) such as a WiFi WLAN AP, in accordance with an exemplary embodiment.

FIG. 14 illustrates an exemplary 3GPP access network, e.g., a 3GPP base station such as, e.g., a 3GPP Citizens Broadband Radio Services (CBRS) gNB base station, in accordance with an exemplary embodiment.

FIG. 15 is an exemplary session management function (SMF) of a core network, e.g., a 5G PLMN core network, in accordance with an exemplary embodiment.

FIG. 16 is an exemplary authentication server function (AUSF) of a core network, e.g., a 5G PLMN core network, in accordance with an exemplary embodiment.

FIG. 17 is an exemplary unified data management or unified data repository (UDM/UDR) of a core network, e.g., a 5G PLMN core network, in accordance with an exemplary embodiment.

FIG. 18 is an exemplary access and mobility management function (AMF) of a core network, e.g., a 5G PLMN core network, in accordance with an exemplary embodiment.

### DETAILED DESCRIPTION

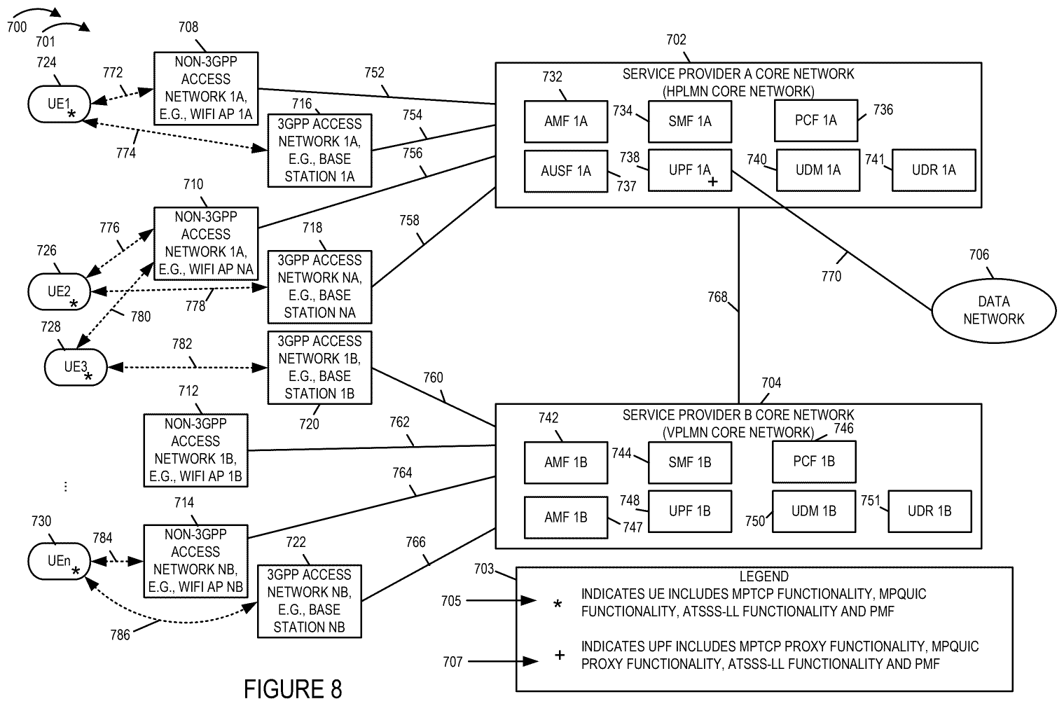

FIG. 8 includes drawing 700, which illustrates an exemplary communications system 701 in accordance with exemplary embodiments of the present invention, and a corresponding legend 703. Exemplary communications system 701 includes a service provider A core network 702, e.g., a HPLMN core network, a service provider B core network 704, e.g., a VPLMN core network. Service provider A core network 702 includes access and mobility management function (AMF) 1A 732, session management function (SMF) 1A 734, policy control function (PCF) 1A 736, authentication server function (AUSF) 1A 737, user plane function (UPF) 1A 738, unified data management (UDM) 1A 740 and unified data repository (UDR) 1A 741. Service provider B core network 704 includes access and mobility management function (AMF) 1B 742, session management function (SMF) 1B 744, policy control function (PCF) 1B 746, authentication server function (AUSF) 1B 747, user plane function (UPF) 1B 748, unified data management (UDM) 1B 750 and unified data repository (UDR) 1B 751. Each of the service provider core networks (702, 704) includes additional functions. In some embodiments, one or both of the service provider core networks (702, 704) include multiple instances of one or more type of functions, e.g., multiple UPFs, multiple SMFs, multiple AMFs, etc. Service provider core A core network 702 is coupled to service provider B core network 704 via communications link 768.

Exemplary communications system 701 further includes a plurality of non-3GPP access networks corresponding to service provider A (non-integrated non-3GPP access network 1A 708, e.g., WiFi AP 1A, . . . , non-integrated non-3GPP access network NA 710, e.g., WiFi AP NA), and a plurality of 3GPP access network corresponding to service provider A (3GPP access network 1A 716, e.g., base station 1A, . . . , 3GPP access network NA 718, e.g., base station NA). The non-3GPP access networks (708, . . . , 710) are coupled to service provider A core network 702 via communications links (752, . . . , 756), respectively. The 3GPP access networks (716, . . . , 718) are coupled to service provider A core network 702 via communications links (754, . . . , 758), respectively.

Exemplary communications system 701 further includes a plurality of non-3GPP access networks corresponding to service provider B (non-integrated non-3GPP access network 1B 712, e.g., WiFi AP 1B, . . . , non-integrated non-3GPP access network NB 714, e.g., WiFi AP NB), and a plurality of 3GPP access network corresponding to service provider B (3GPP access network 1B 720, e.g., base station 1B, . . . , 3GPP access network NB 722, e.g., base station NB). The non-3GPP access networks (712, . . . , 714) are coupled to service provider B core network 704 via communications links (762, . . . , 764), respectively. The 3GPP access networks (720, . . . , 722) are coupled to service provider B core network 704 via communications links (760, . . . , 766), respectively.

Exemplary communications system 701 further includes a plurality of user equipments (UE1 724, UE2 726, UE3 728, . . . , UEn 730). At least some of the UEs are mobile wireless communications devices which may be attached to different non-3GPP access network and/or different 3GPP access networks at different times. At least some of the UEs are DSDS (Dual SIM Dual Standby) UEs. Exemplary communications system 701 further includes data network (DN) 706 coupled to UPF 1A 738 via connection 770.

In the example of FIG. 8, UE1 724 is coupled to non-3GPP access network 1A 708 via wireless link 772 and is coupled to 3GPP access network 1A 712 via wireless link 744. In the example of FIG. 8, UE2 726 is coupled to non-3GPP access network NA 710 via wireless link 776 and is coupled to 3GPP access network NA 718 via wireless link 778. In the example of FIG. 8, UE3 728 is coupled to non-3GPP access network NA 710 via wireless link 780 and is coupled to 3GPP access network 1B 720 via wireless link 782. In the example of FIG. 8, UEn 730 is coupled to non-3GPP access network NB 714 via wireless link 784 and is coupled to 3GPP access network NB 722 via wireless link 786.

Legend 703 includes: i) information 705 indicating that “*” indicates the UE include MPTCP functionality, MPQUIC functionality, ATSSS-LL functionality and PMF; and ii) information 707 indicating that “+” indicates that the UPF includes MPTCP proxy functionality, MPQUIC proxy functionality, ATSSS-LL functionality and PMF. Various devices, e.g., including UEs (724, 726, 728, 730), AMF 732, non-integrated non-3GPP access networks (708, 710), 3 GPP access networks (716, 718), UPF (738), SMF (734), AUSF (737), UDM (740), UDR (741), in FIG. 8 are also implemented to incorporate novel features of the present invention and facilitate implementation of the methods in accordance with the present invention.

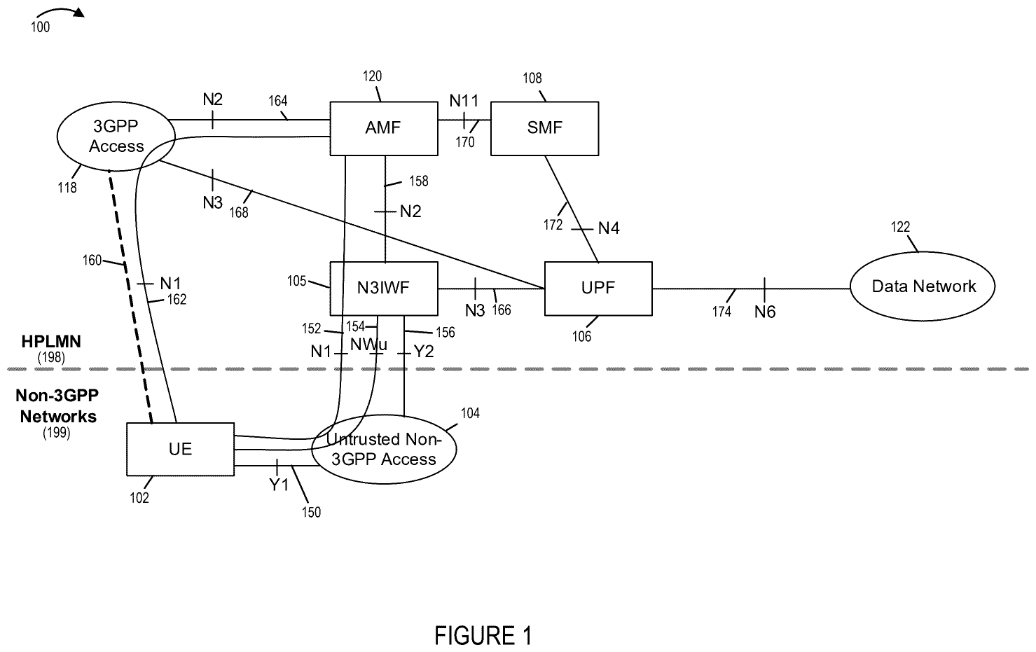

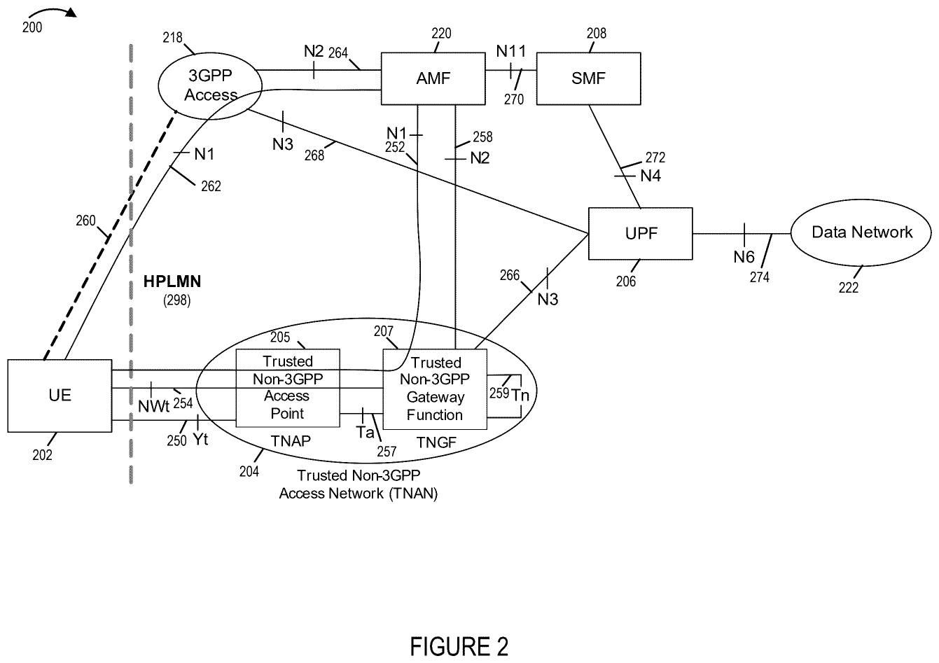

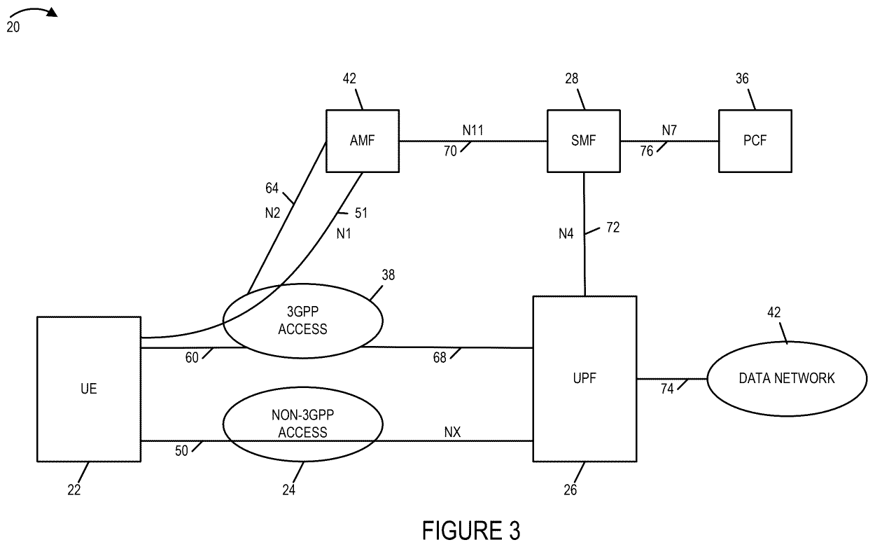

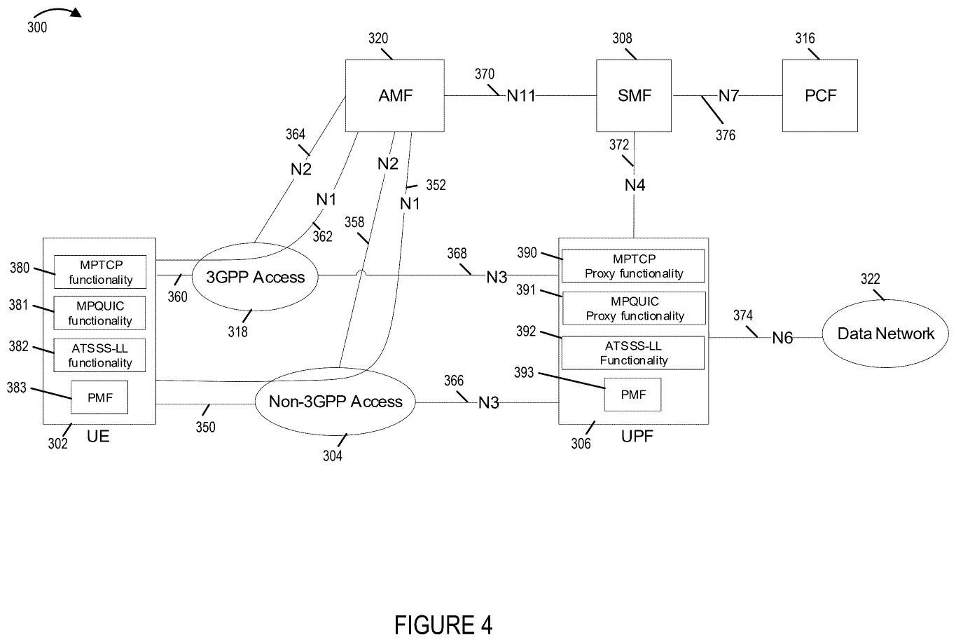

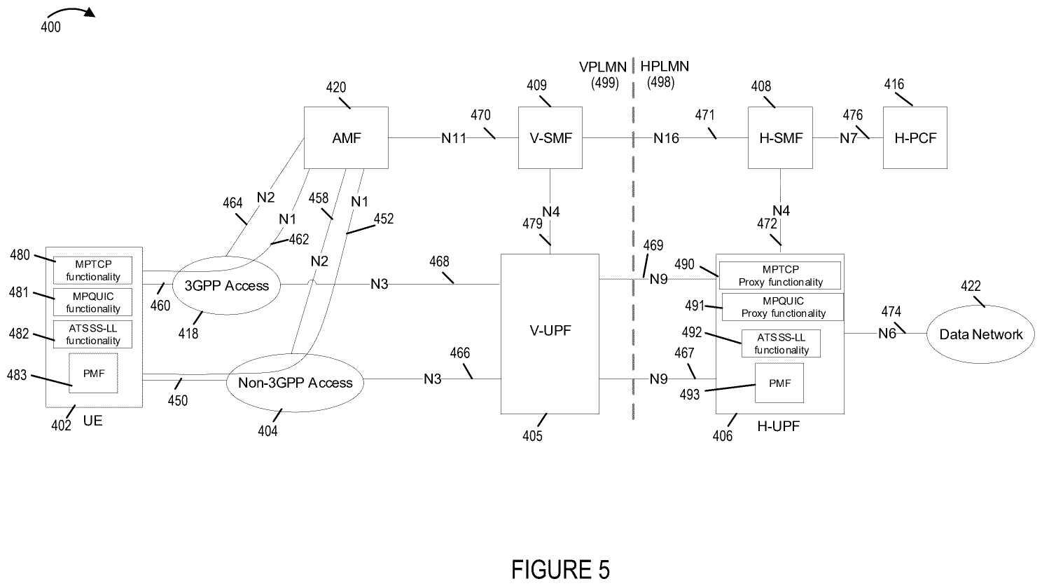

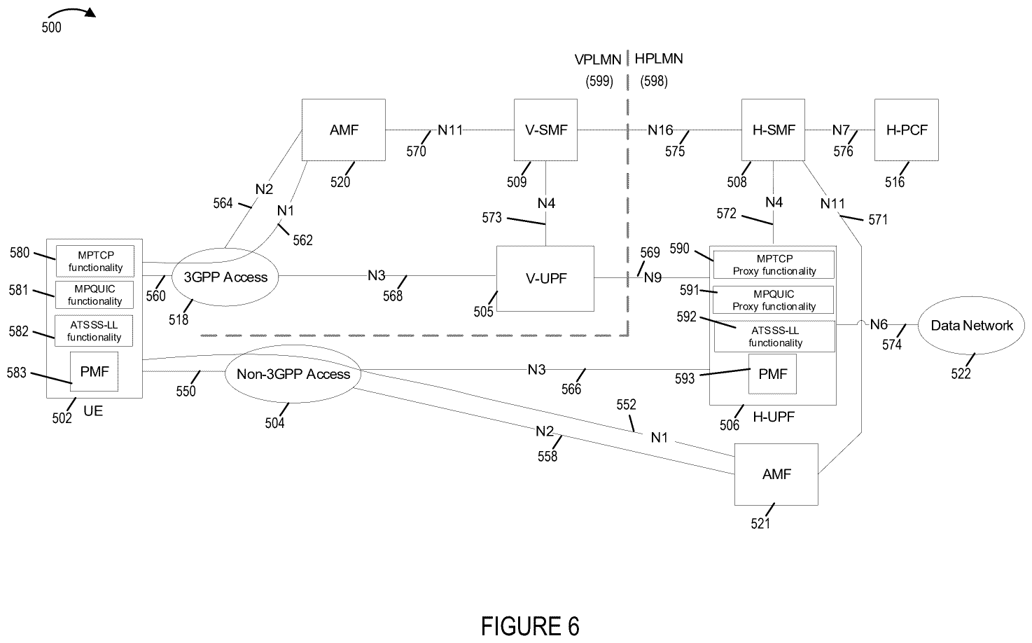

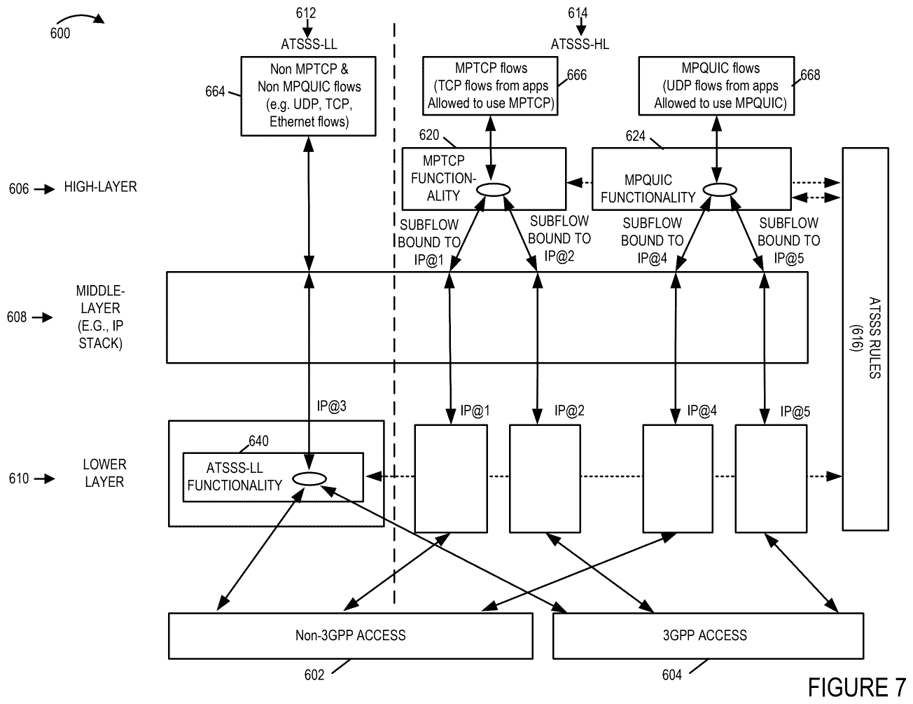

In FIG. 8, UE1 724 and UE 726 may correspond to examples, in accordance with the present invention, corresponding to a similar architecture as to that shown in FIG. 4 (non-roaming and roaming with local breakout for ATSSS support). In FIG. 1, UEn 730 may correspond to an example, in accordance with the present invention, corresponding to a similar architecture as to that shown in FIG. 5 (roaming with home-routed architecture for ATSSS support (UE registered to the same VPLMN). In FIG. 8, UE3 728 may correspond to an example, in accordance with the present invention, corresponding to a similar architecture as to that shown in FIG. 6 (roaming with home-routed architecture for ATSSS support (UE registered to different PLMNs).

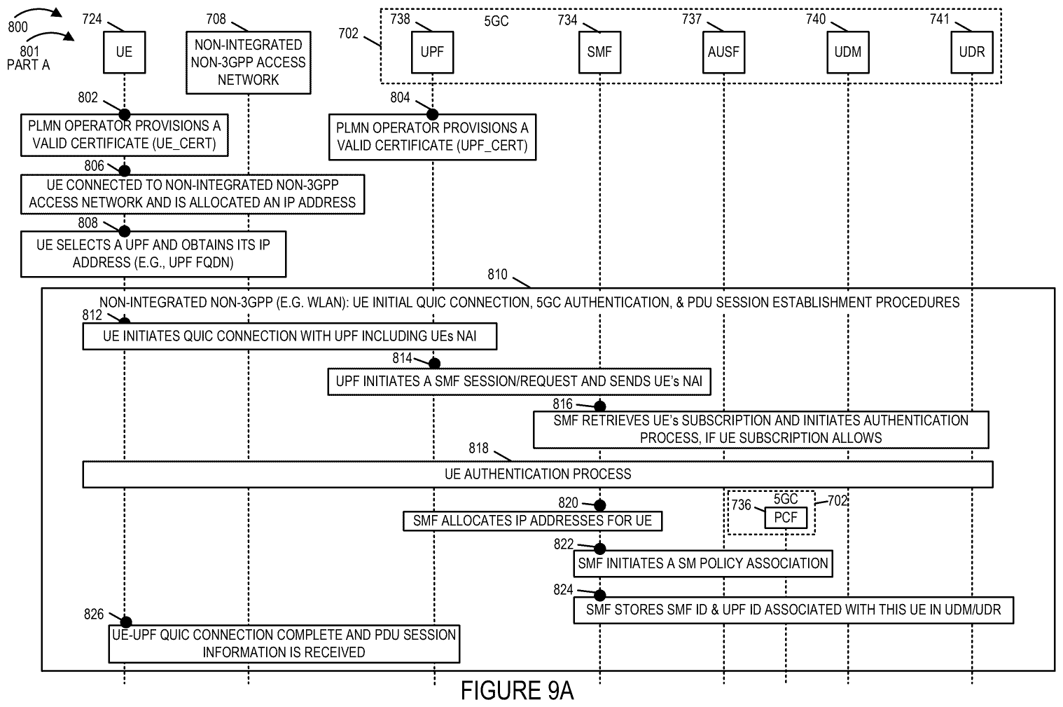

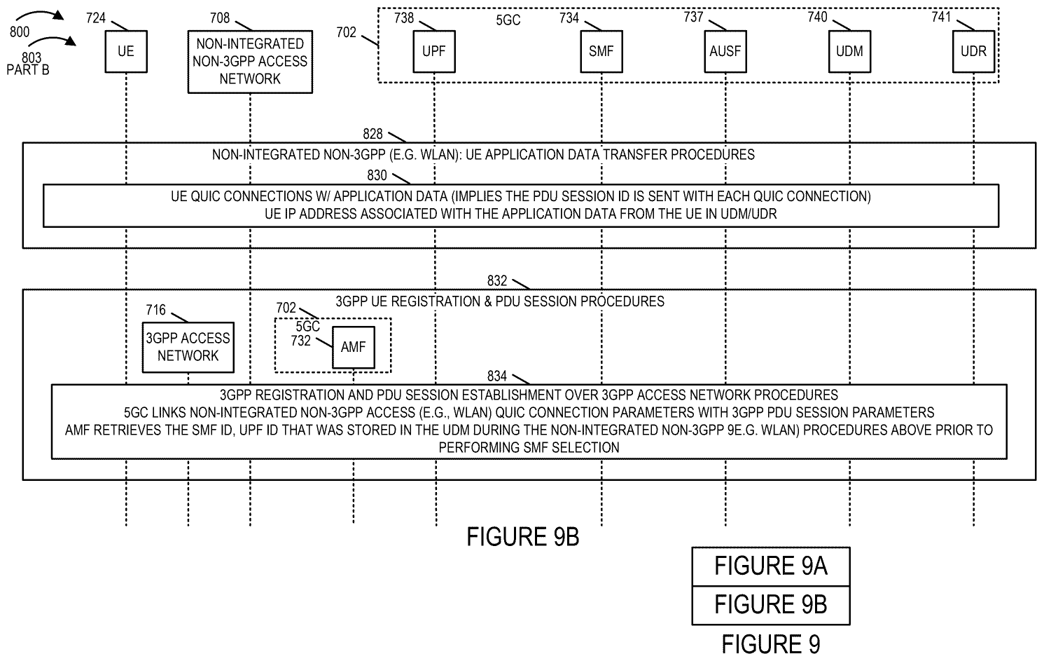

FIG. 9, comprising the combination of FIG. 9A and FIG. 9B, is a drawing 800, comprising Part A 801 and Part B 803, illustrating exemplary components of an exemplary system, steps and/or signaling used in an exemplary method in accordance with an embodiment of the present invention. FIG. 9 illustrates a new UE authentication and QUIC Connection Setup procedure for Non-integrated non-3GPP, e.g., WLAN, access.

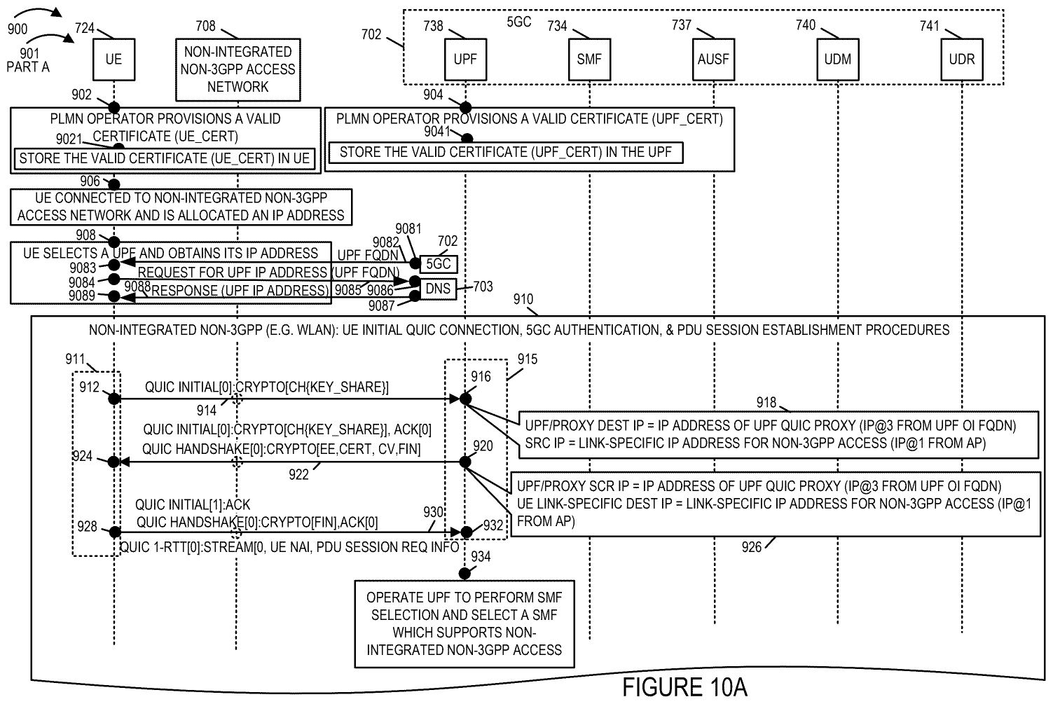

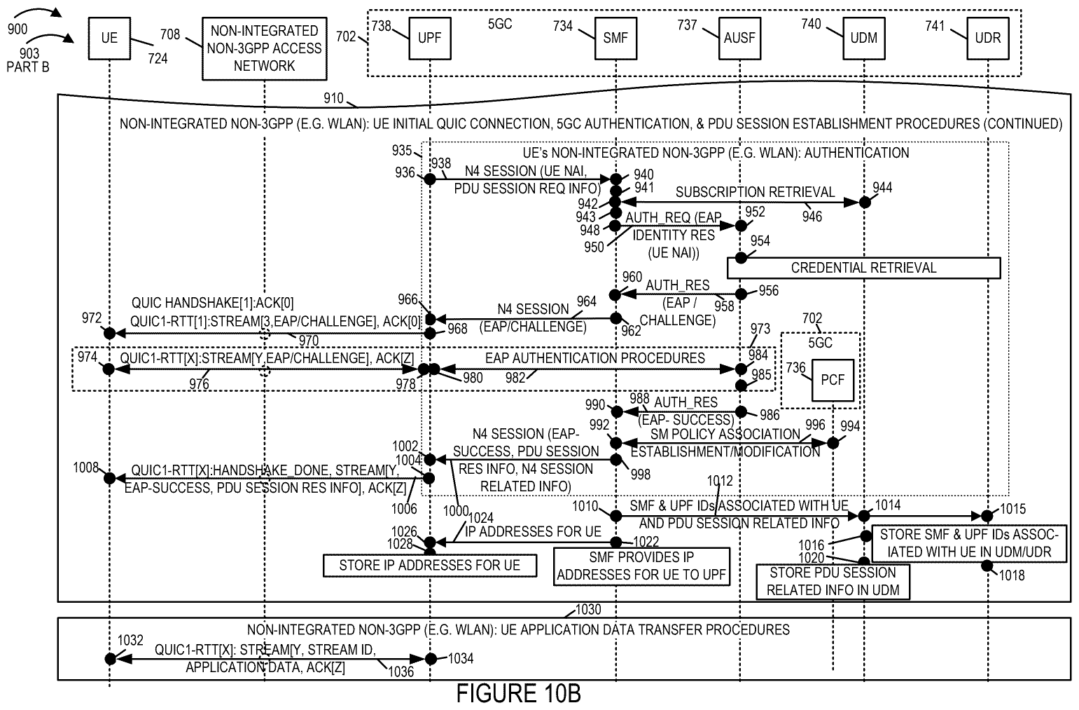

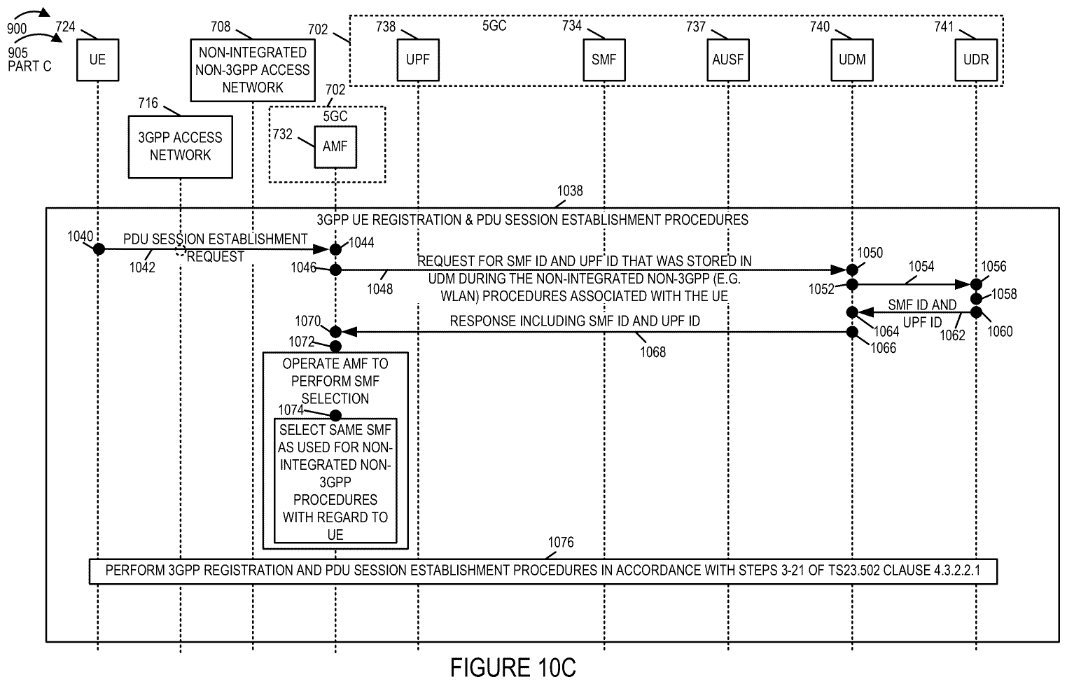

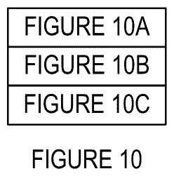

FIG. 10, comprising the combination of FIG. 10A, FIG. 10B and FIG. 10C, is a drawing 900, comprising Part A 901, Part B 903 and Part C 905, illustrating exemplary components of an exemplary system, steps and/or signaling used in an exemplary method in accordance with an embodiment of the present invention. FIG. 10 illustrates a new UE authentication and QUIC Connection Setup procedure for Non-integrated non-3GPP, e.g., WLAN, access.

The methods of FIG. 9 and FIG. 10 are, e.g., implemented by system 701 of FIG. 8 including, e.g., UE1 724, non-integrated non-3GPP access network 1A 708, UPF 1A 738, SMF 1A 734, AUSF 1A 737, UDM 1A 740, UDR 1A 741. 3GPP access network 716 and AMF 732.

In the FIGS. 9 and 10 examples:

Both UE 724 and UPF 738 are optionally pre-provisioned with certificates (i.e., UE_cert & UPF_cert).

UE 724 is pre-provisioned with the Fully Qualified Domain Name (FQDN) of the UPF 738 to be connected over WLAN (e.g., non-integrated non-3GPP access 708). This FQDN can also be, and sometimes is, incorporated in Access Network Discovery and Selection Policy (ANDSP) or UE Route Selection Policy (URSP) rules.

UE 724 initiates a Quick UDP Internet Connections (QUIC) connection with the UPF 738 and includes UE's Network Access Identifier (NAI) in a subsequent encrypted QUIC packet to initiate Extensible Authentication Protocol (EAP) authentication with the 5GC 702.

Note: Sending UE's NAI to initiate authenticating to 5GC 702 can occur during the UE 724 & UPF 738 QUIC initial connection setup or after the initial connection has been successfully established.

Note: Other tunneling protocols (i.e., IPsec) are also feasible and are used in some embodiments for establishing a connection between the UE 724 and UPF 738, with mutual authentication being performed in various embodiments.

During the UE 724 and UPF 738 connection establishment, it is possible to start the process of the UE 724 authenticating to 5GC 702 as well as the UPF 738 initiating the retrieval of the UE's subscription, via UPF 738 sending a SMF session/request once the UPF 738 receives the UE NAI.

When the SMF 734 receives a N4 Session request (a new 3GPP

message) from the UPF 738, the SMF 734 will retrieve UE 724 subscription information from the UDM/UDR (740/741) and initiate the authentication process, if the UE 724 subscription allows.

The UE 724 performs authentication to the 5GC 702 using QUIC encrypted messages carrying the UE NAI and EAP/challenge payloads. The UE 724 also provides QUIC encrypted messages carrying PDU Session request information as defined in TS23.502 clause 4.3.2.2.1 step 1.

After UE 724 authentication to the 5GC 702 is complete, the SMF 734 will initiate an SM Policy Association with the PCF 736.

The SMF 734 also stores at least the SMF ID and UPF ID associated with the UE 724 in the UDM/UDR (740/741).

If the UE 724 authentication to the 5GC 702 is successful, the UPF 738 will complete the QUIC connection by providing a QUIC HANDSHAKE_DONE packet and a QUIC encrypted message carrying EAP-Success along with the PDU Session response information as defined in TS23.502 clause 4.3.2.2.1 step 12 and 13. If the authentication to the 5GC 702 is not successful, the UPF 738 may reject the QUIC connection with the UE 724.

At this point the user plane connection is established and the UE 724-UPF 738 are able to transfer application data via a WLAN 708 (i.e., non-3GPP non-integrated access) QUIC connection. Any PDU Session related information for the application data may also be sent with each QUIC connection.

Once the UE 724 establishes a 3GPP connection and initiates a MA PDU Session via 3GPP, the information stored in the UDM/UDR (740/741) (i.e., SMF ID, UPF ID that was stored during the WLAN procedures above by using Nudm_SDM_Get Request (Subscription Permanent Identifier (SUPI), UE context in SMF data, . . . ), etc.) is retrieved by the AMF 732 prior to initiating SMF selection. This also enables linkage between the UE's WLAN access QUIC Application data and the 3GPP access QUIC Application data.

UE (e.g., WLAN access) Initial QUIC Connection & 5GC Authentication Procedures, in accordance with the present invention will now be described.

Relevant signaling flows in FIGS. 9 and 10 illustrate examples of how the UE 724 establishes a QUIC connection with 5GC 702 and performs 5GC authentication.

The QUIC initial connection follows the same procedures or similar procedure to those described in RFC9000 section 7.1. FIG. 5, which is discussed below and incorporated by reference in its entirety. As an illustration of a possible solution, the EAP authentication process between the UE and 5GC is embedded within the QUIC initial connection establishment. It is also possible to establish the QUIC connection first and then send subsequent QUIC messages for UE authentication to the 5GC.

The exemplary new UE authentication and QUIC Connection Setup procedure for Non-integrated non-3GPP, e.g., WLAN, access of FIG. 9 will now be described. In step 802 the PLMN operator, e.g., PLMN Operator A, provisions UE 724 with a valid certificate (UE_cert). In step 804 the PLMN operator, e.g., PLMN operator A corresponding to the 5GC 702, provisions UPF 738 with a valid certificate (UPF_cert). In step 806 UE 724 is operated to connect to non-integrated non-3GPP access network 708 and is allocated an IP address. In step 808 UE 724 selects a UPF, e.g. UE selects a UPF, which supports non-integrated non-3GPP access in accordance with the methods of the present invention, which is a UE corresponding to a pre-provisioned UPF FQDN, which is UPF 738, and UE 724 uses the pre-provisioned UPF FQDN to obtain the UPF's IP address, e.g., via querying a DNS (Domain Name Server). This provisioning of the UPF FQDN, in the UE 724, is done by the network operator via ANDSP (Access Network Discovery and Selection Policy) or URSP (UE Route Selection Policy) rules or via initial configuration of the UE 724 by the network operator, e.g., PLMN operator A. For example, by querying the DNS using the pre-provisioned UPF FQDN, the IP address of a UPF which supports non-integrated non-3GPP access, in accordance with the methods of the present invention, is obtained.

Block 810 includes non-integrated non-3GPP (e.g., WLAN): UE initial QUIC connection, 5GC authentication & PDU session establishment procedures. In step 812 UE 724 initiates a QUIC connection with UPF 738. Some signaling communicated from the UE 724 to the UPF 738, as part of establishing a QUIC connection, includes signaling communicating the UE's Network Access Identifier (NAI) to the UPF 738. In step 814 UPF 814 initiates a SMF session/request and sends the UE's NAI to the SMF 734. In step 734 SMF 734 retrieves the UE's subscription from UDM.UDR (740/741) and initiates an authentication process, if the UE 724 subscription allows. In step 818 a UE 724 authentication process is performed. In step 820 SMF 734 allocates IP addresses for UE 724, and communicates the allocated IP addresses for UE 724 to UPF 738. In step 822 SMF 734 initiates a SM policy association. In step 824 SMF 734 stores the SMF ID and UPF ID associated with this UE 724 in UDM/UDR (740/741). In step 826 the UE 724-UPF 738 will complete the QUIC connection, e.g., by the UPF 738 providing a QUIC HANDSHAKE_DONE packet and a QUIC encrypted message carrying EAP-Success along with the PDU Session response information to UE 724, which is received by the UE 724.

Block 828 includes non-integrated non-3GPP (e.g., WLAN): UE application data transfer procedures. Information block 830 indicates that UE QUIC connections (between UE 724 and UPF 738) are used to communicate application data between UE 724 and UPF 738 via the non-integrated non-3GPP Access network 708. The PDU session ID is sent with each QUIC connection. The UE IP address is associated with the Application data from the UE in the UDM/UDR.

Block 832 includes 3GPP UE registration & PDU session procedures. Information block 834 indicates that 3GPP UE 724 registration and PDU session establishment over 3GPP access network 716 procedures are performed. As part of the 3GPP Registration and PDU session establishment procedures, the 5GC 702 links the non-integrated non-3GPP access (e.g., WLAN) QUIC connection parameters with 3GPP PDU session parameters. AMF 732 retrieves the SMF ID and UPF ID that was stored in the UDM in step 824 during the non-integrated non-3GPP (e.g., WLAN) procedures 810, prior to performing SMF selection for 3GPP access.

The exemplary new UE authentication and QUIC Connection Setup procedure for Non-integrated non-3GPP, e.g., WLAN, access of FIG. 10 will now be described. In step 902 the PLMN operator, e.g., PLMN Operator A, provisions UE 724 with a valid certificate (UE_cert). In step 9021 UE 724 stores the valid certificate (UE_cert) in memory in UE 724. In step 904 the PLMN operator, e.g., PLMN operator A corresponding to the 5GC 702, provisions UPF 738 with a valid certificate (UPF_cert). In step 9041 UPF 738 stores the valid certificate (UPF_cert) in memory in UPF 738.

In step 906 UE 724 is operated to connect to non-integrated non-3GPP access network 708, e.g., a non-integrated non-3GPP WiFi access point, and is allocated an IP address. In step 908 UE 724 selects a UPF, e.g. UE selects a UPF, which supports non-integrated non-3GPP access in accordance with the methods of the present invention, which is a UPF corresponding to a pre-provisioned UPF FQDN, which is UPF 738, and UE 724 uses the pre-provisioned UPF FQDN to obtain the UPF's IP address, e.g., via querying a DNS (Domain Name Server). The pre-provisioning of the UPF FQDN, in the UE 724, is done by the network operator, e.g., PLMN operator A, via ANDSP (Access Network Discovery and Selection Policy) or URSP (UE Route Selection Policy) rules or via initial configuration of the UE 724 by the network operator, e.g., PLMN operator A. For example, by querying the DNS using the pre-provisioned UPF FQDN, the IP address of a UPF which supports non-integrated non-3GPP access, in accordance with the methods of the present invention, (e.g., the IP address of UPF 738) is obtained.

In some embodiments, UE 724 is pre-provisioned with multiple alternative UPF FQDNs, each pre-provisioned alternative UPF FQDN corresponding to a different UPF which supports non-integrated non-3GPP access, in accordance with the methods of the present invention, and UE 724 selects one of the alternative pre-provisioned UPF FQDNs and obtains the selected UPFs IP address, e.g., from the DNS.

In some embodiments, step 908 includes steps 9083, 9084 and 9089. In step 9081 network operator A, e.g. 5GC of network 702 of network operator A, provisions UE 724 with a FQDN of a UPF, e.g., UPF 738, which supports non-integrated non-3GPP access in accordance with the methods of the present invention. For example, in step 9081 5GC 702 generates and sends message 9082 to UE 724, wherein message 9082 includes a UPF FQDN which corresponds to UPF 738. In step 9083, UE 724 receives message 9082, recovers and stores the provisioned UPF FQDN. In various embodiments, steps 9081 and 9082 are performed prior to step 906, e.g., UE 724 is pre-provisioned with a UPF FQDN before connecting to the non-integrated non-3GPP access network in step 906. In step 9084 UE 724 generates and sends a request message 9085 including the UPF FQDN to DNS 703, said request message 9085 requesting a UPF IP address corresponding to the UPF FQDN. In step 9086 DNS 703, receives the request message 9085, recovers the communicated FQDN, processes the request and determines the UPF IP address corresponding to the FQDN. In step 9087 DNS 703 generates and sends response message 9088 to UE 724, said response message 9088 including the recovered UPF IP address. In step 9089 UE 724 receives response message 9088 and recovers the communicated UPF IP address, e.g., an IP address corresponding to UPF 738.

Block 910 includes non-integrated non-3GPP (e.g., WLAN): UE initial QUIC connection, 5GC authentication & PDU session establishment procedures. UE 724 starts the QUIC Initial Connection procedure to UPF 738. In step 912 UE 724 generates and sends QUIC Initial[0]: CRYPTO[CH{key_share}] message 914 to UPF 738, which is received and recovered by UPF 738 in step 916. Note 918 indicates that the UPF/Proxy Destination IP=IP address of UPF QUIC proxy (IP@3 from UPF Operator Identifier (OI) FQDN) and Source IP=link-specific IP address for non-3GPP access (IP@1 from AP).

In step 920, UPF 738 generates and sends QUIC Initial[0]: CRYPTO[SH{key_share}], ACK[0] message and QUIC Handshake[0]: Crypto[EE,CERT, CV, FIN] messages 922 to UE 724, which are received and recovered by UE 724 in step 924. Note 926 indicates that the UPF/Proxy Source IP=IP address of UPF QUIC proxy (IP@3 from UPF OI FQDN) and UE link-specific Destination IP=link-specific IP address for non-3GPP access (IP@1 from AP).

In steps 928, UE 724 generates and sends messages 930 including i) QUIC Initial[1]: ACK[0]; ii) QUIC Handshake[0]: CRYPTO[FIN], ACK[0]; and iii) QUIC 1-RTT[0]: STREAM[0, UE NAI, PDU Session Request information] to UPF 738, which are received and recovered by UPF 738 in step 932. A novel feature in accordance with the present invention is that the UE 724 includes and sends the UE NAI and the PDU Session request information to the UPF 738, e.g., in the QUIC 1-RTT[0]: STREAM[0, UE NAI, PDU Session Request information] message.

In step 915, which includes steps 916, 920 and 932, UPF 738 uses the stored certificate corresponding to the UPF 738 (UPF_CERT) to establish a secure connection between UE 724 and UPF 738. In step 911, which includes steps 912, 924 and 928, UE 724 uses the stored certificate corresponding to the UE 724 (UE_CERT) to establish a secure connection between UE 724 and UPF 738. For example, a QUIC connection, which is based on a security handshake and/or mutual authentication procedure which relies on a stored certificate (UE_CERT) in UE 724 corresponding to the UE 724 is used to authenticate the UE 724 to UPF 738 and a stored certificate (UPF_CERT) in the UPF 738 is used to authenticate the UPF 738 to the UE 708, where the secure connection is between the UE 724 and UPF 738 and traverses a non-integrated non-3GPP access network 708.

In step 934 UPF 738 selects a SMF, e.g., selects SMF 734, that supports non-integrated non-3GPP access (e.g., WLAN), in accordance with the method of the present invention. In various embodiments, 5GC 702 includes a plurality of alterative SMFs and some of the SMFs support non-integrated non-3GPP access while others do not.

Block 935, which is part of block 910, includes UE 724 non-integrated non-3GPP (e.g., WLAN) authentication procedures. In step 936, UPF 738 generates and sends a novel N4 Session message 938 including the UE NAI (Network Address Identifier) and PDU (Protocol Data Unit) session request information to SMF 734. In step 940 SMF 734 receives the N4 session message 938 and recovers the communicated information including the UE NAI and PDU session request information. Based on the received UE NAI, the SMF 724, in step 941, triggers the authentication procedure. In steps 942 and 944 the SMF 734 and UDM 740 perform operations including communicating signaling 946 for subscription retrieval, e.g., subscription information corresponding to the UE 724 is requested by the SMF 734 from the UDM 740 and communicated to the SMF 734. In step 947 SMF determines, based on the retrieved subscription information, that an authentication process is allowed and initiates an authentication process. In step 948 SMF 734 constructs an EAP Response/Identify message that includes the UE NAI, generates an Nausf_SMauthentication_Authenticate Request message 950 including the EAP Response/Identify message including the UE NAI, and sends the Nausf_SMauthentication_Authenticate Request message 950 to AUSF 737. In step 952 the AUSF 737 receives the Nausf_SMauthentication_Authenticate Request message 950 and recovers the communicated information including the EAP Response/Identify message including the UE NAI.

In step 954 the AUSF 737 performs credential retrieval operations. For example, in step 954 the AUSF 737 selects a UDM, e.g., UDM 740, as described in clause 6.3.8 of TS 23.501 and obtains the authentication data from UDM 740 for this UE 724.

In step 956, based on the UE authentication data, the AUSF 737 creates the EAP-Request/AKA′-Challenge message to the SMF 734, incorporates the EAP-Request/AKA′-Challenge message in a Nausf_SMAuthentication_Authenticate Response message 958 being generated and sends the Nausf_SMAuthentication_Authenticate Response message 958 including the EAP-Request/AKA′-Challenge message to the SMF 734, which receives message 958 in step 960.

The SMF 734, in step 962 transparently forwards the EAP-Request/AKA′-Challenge message to the UPF 734 via the related Packet Forwarding Control Protocol (PFCF) session, e.g., as part of a N4 session communications 964. In step 966, UPF 738 recovers the N4 session communications 964 including the EAP-Request/AKA′-Challenge message and recovers the communicated information.

Then, in step 968 the UPF 738 sends the EAP-Request/AKA′-Challenge message to the UE 724 via QUIC packet message, e.g., as part of QUIC packets messages 970, which includes QUIC Handshake[1]: ACK[0] and QUIC 1-RTT[1]: STREAM[3, EAP/Challenge], ACK[0]. In step 972 UE 724 receives QUIC packet messages 970 and recovers the communicated information. The QUIC packets messages exchanged between the UE 724 and the UPF 738 are the same as the IKEv2 messages exchanged between the UE and the ePDG as defined in 3GPP standards document TS 33.402[20] subclause 8.2.2, except they are carried in QUIC packets.

In steps 984 and 974, the AUSF 737 and the UE 724 exchange EAP-Request/Response messages via the SMF 734 and UPF 738, as part of EAP authentication procedures 973. The SMF 734 and UPF 738, shall transparently forward these messages. Signaling QUIC-RTT[X]: STREAM [Y, EAP/Challenge], ACK[Z] 976 shows an exemplary EAP/challenge being communicated along a path portion between UE 724 and AUSF 737 as part of EAP authentication procedures. Note that EAP request/response messages are communicated via QUIC packet messages for the path portion between UE 724 and UPF 738, with steps 978 and 980 being performed at UPF 738 to include/remove the information within QUIC packet messages.

In step 985 the AUSF determines the result of the authentication, e.g., the AUSF 737 determines that UE 724 has been successfully authenticated.

After the UE 724 is successfully authenticated, the AUSF 737, in step 986, generates an EAP-Success message, includes the generated-EAP success message in a Nausf_SMAuthentication_Authenticate Response message 988 being generated, and sends the Nausf_SMAuthentication_Authenticate Response message 988 including the EAP success message to the SMF 734, which receives the message 988 in step 990 and recovers the communicated information.

In steps 992 and 994 the SMF 734 and PCF 716 perform operations to communicate SM policy association establishment/modification information 996.

In step 998 SMF 734 generates N4 session (EAP-success, PDU session response information, N4 session related information) message 1000 and sends the message 1000 to UPF 738. Thus, in step 998 the SMF 734 forwards the EAP-Success message from authentication response message 988 to the UPF 734 via N4 Session message 1000 and also communicates PDU session response information, e.g., based on information from SM policy association establishment/modification signaling 996, to UPF 738 via N4 Session message 1000.

In step 1004 UPF 738 generates and sends QUIC-RTT[X]: HANDSHAKE_DONE, STREAM[Y, EAP-Success, PDU Session Response Information], ACK[Z] 1006 to UE 724. Thus, in step 1004 the UPF 738 sends EAP-Success message to the UE 724 and completes the QUIC initial connection establishment procedure. In step 1008 the UE 724 receives the QUIC-RTT [X]: HANDSHAKE_DONE, STREAM[Y, EAP-Success, PDU Session Response Information], ACK[Z] 1006, recovers the communicated information and recognizes that the UE 724 has been successfully authenticated.

In step 1010 SMF 734 generates and sends message 1012 to UDM 740 and/or to UDR 741, said message 1012 communicating the SMF & UDF IDs associated with UE 724 and PDU session related information. In step 1014 the UDM 740 receives message 1012 and recovers the communicated information. In step 1015 the UDR 741 receives message 1012 and recovers the communicated information. In step 1016 UDM 740 stores the SMF and UPF IDs associated with the UE 724 in the UDM 740. In step 1020 the UDM 740 stores the PDU session related information in the UDM 740.

In step 1022 SMF 734 provides IP addresses for UE 724 to UPF 738, e.g., SMF 734 generates and sends message 1024 to UPF 734, which includes IP addresses for UE 724. In step 1026 UPF 738 receives message 1024 and recovers the SMF provided IP addresses for UE 724. In step 1028, UPF 738 stores the SMF provided IP addresses for UE 724 corresponding to the session.

Block 1030 includes non-integrated non-3GPP (e.g., WLAN) UE application data transfer procedures. In steps 1032 and 1034 the UE 724 and UPF 738 are operated to communicate UE application data via QUIC-RTT[X]: STREAM[Y, Stream ID, application data], ACK[Z] 1036.

Block 1038 includes 3GPP UE registration & PDU session establishment procedures. In step 1040 UE 724 generates and sends, via 3GPP access network 716, PDU session establishment request 1042 to AMF 732, which is received by the AMF 732 in step 1044. In step 1046 AMF 732 generates and sends a request 1048, for the SMF ID and UPF ID that was stored (e.g., in step 1016 and/or 1018) in the UDM 740 and/or UDR 741 during the non-integrated non-3GPP (e.g., WLAN) procedures associated with the UE 724, to the UDM 740. In step 1050, UDM 740 receives the request 1048. In some embodiments, the UDM 740 has a stored local copy of the SMF ID and UPF ID associated with UE 724 and retries the information. In other embodiments, UDM 740 sends a request message 1054 to UDR 741 requesting the SMF ID and UPF ID associated with UE 724, and in step 1058 the UDR receives the request 1054. In step 1058 the UDR 741 retrieves the requested information from its storage. In step 1060 UDR 741 generates and sends a response message 1062 to UDM 740 communicating the SMF ID and UDP ID associated with UE 724 which is being used for non-integrated non-3GPP access. In step 1064, UDM 740 receives response message 1062 and recovers the communicated information. In step 1066 UDM 740 generates a response message 1068 including the SMF ID and UPF ID associated with UE 724 for non-integrated non-3GPP access and sends the generated response message 1068 to AMF 732. In step 1070 AMF 732 receives response message 1068 and recovers the communicated information. In step 1072 the AMF 732 is operated to perform a SMF selection, which selects the AMF to be used for 3GPP for UE 724. In some embodiments, the AMF 732 selects, in step 1074, the same SMF for 3GPP as the SMF used for non-integrated non-3GPP procedures with regard to the UE 724.

In step 1076 3GPP registration and PDU session establishment procedures are performed, by the communications system including UE 724, 3GPP access network 716, and 5GC 702 including AMF 732, UPF 738, SMF 734, AUSF 737, UDM 740 and UDR 741, in accordance with steps 3-21 of TS23.502 clause 4.3.2.2.1.

Various significant features and/or aspects of the signaling flow 900 of FIG. 10 will now be described.

Steps 908, 912, 916 and signals 914: The UE (724) selects (908) a UPF (738) and obtains its IP address (e.g. UPF FQDN) and UE (724) starts (912) the QUIC Initial Connection procedure to the UPF (738).

Steps 928, 932 and signals 930: UE (724) sends (928) the UE NAI and the PDU Session request information to the UPF (738).

Steps 934, 936, 940 and signals 938: UPF (738) selects (934) an SMF (734) that supports non-integrated non-3GPP access (e.g. WLAN), then sends (936) the UE NAI to the SMF (734) via a N4 Session message (new message) 938.

Steps 941, 942, 944, 948, 952 and signals 946, 950: Based on the received UE NAI, the SMF (734) triggers (941) the authentication procedure. The SMF (734) constructs (948) an EAP Response/Identity message that contains the UE NAI and sends the EAP Response/Identity message within Nausf_SMauthentication_Authenticate Request message (950) to the AUSF (737).

Step 954: The AUSF (737) selects (952) a UDM as described in clause 6.3.8 of TS 23.501[3] and obtains (954) the authentication data from UDM (740) for this UE (724).

Steps 956, 960, 962, 966, 968, 972 and signals 958, 964, 970: Based on the UE (724) authentication data, the AUSF (737) creates (956) the EAP-Request/AKA′-Challenge message to the SMF (734) in a Nausf_SMAuthentication_Authenticate Response message (958). The SMF (734) transparently forwards (962) the EAP-Request/AKA′-Challenge message to the UPF (738) via the related PFCF session (964). Then the UPF (728) sends (968) the EAP-Request/AKA′-Challenge message to the UE (723) via QUIC packet message 970). The QUIC packets messages exchanged between the UE (724) and the UPF (738) are the same as the IKEv2 messages exchanged between the UE and the ePDG as defined in 3GPP standards document TS 33.402 subclause 8.2.2, except they are carried in QUIC packets.

Steps 984, 974, 980, 978 and signals 976, 982: The AUSF (737) and the UE (724) may exchange (984, 974) EAP-Request/Response messages via the SMF (734) and UPF (738). The SMF (734) and UPF (738) shall transparently forward (978, 980) these messages.

Steps 985, 986, 990, 992, 994, 998, 1002 and signals 988, 996, 1000: After the UE (724) is successfully authenticated (985), the AUSF (737) sends (986) an EAP-Success message to the SMF (734) inside Nausf_SMAuthentication_Authenticate Response message (988). The SMF (734) forwards (998) the EAP-Success message to the UPF (738) via N4 Session (1000).

Steps 1002, 1008 and signals 1006: The UPF (738) sends (1004) EAP-Success message to the UE (724) and completes the QUIC initial connection establishment procedure.

Steps 1010, 1014, 1016, 1018, 1020, 1022, 1026, 1028: The SMF ID & UPF ID associated with this UE (724) is stored (1016, 1018, 1020) in the UDM/UDR (740/741) as well as the PDU session related information which is also stored (1020) in the UDM (740) and/or UDR (741). Also, the SMF (734) provides (1022) IP addresses (1024) for the UE (724) to UPF (738). These step can be, and in some embodiments are, done in parallel or before steps 1002, 1008, as well.

UE 3GPP access Registration & PDU Session Procedure enhancements, in accordance with features of the present invention, will now be described. The signaling flow of the 3GPP UE Registration & PDU Session Establishment procedures (1038) of FIG. 10 is similar to TR23.700 clause 6.2.8.2.2 with the addition that before step 2 of TS23.502 4.3.2.2.1, the AMF (732) retrieves (in steps 1044, 1070) the SMF ID, UPF ID that was stored (in step 1016) in the UDM (740) during the WLAN (non-integrated non-3GPP access) procedures (910) prior to performing SMF selection (1072) for 3GPP.

Impacted/modified nodes which are implemented in accordance with and to support features of the present invention include: UDM, e.g., UDM 740, UPF, e.g., UPF 738, SMF, e.g., SMF 734, AMF, e.g., AMF 732, AUSF, e.g. AUSF 737, and UE, e.g. UE 724.

UDM:

SMF stores SMF ID & UPF ID associated with this UE in UDM/UDR

Subscription support for SMF to retrieve UE's subscription and initiates authentication process.

UPF:

ATSSS with MPQUIC connectivity without GTP-U tunnel.

Supports the non-integrated non-3GPP access (e.g. WLAN) functionality, including allocation of the public IP address for this functionality.

SMF selection that supports non-integrated non-3GPP access (e.g., WLAN).

Initiating an N4 Session request without an N4 Session being available for the UE.

Forwarding UE NAI, PDU Session request/response related information, and EAP messages to the SMF via the N4 interface or to UE via QUIC connection.

SMF:

Supports a new interface with AUSF for exchanging the new Nausf_SMAuthentication_Authenticate Request/Response messages.

N4 interface enhanced to transport the UE NAI, EAP messages, even without having an N4 Session.

Support of MA PDU Sessions via non-integrated non-3GPP access without a NAS connection via non-3GPP access. This includes handling of the MA PDU Session in case the UE is not reachable via 3GPP access.

AMF:

AMF retrieve the SMF ID, UPF ID that was stored in the UDM during the non-integrated non-3GPP (e.g., WLAN) procedures prior to performing SMF selection in the 3GPP procedures.

Support for new capability indications to/from UE and support for selecting SMF supporting simplified ATSSS over non-integrated non-3GPP access.

AUSF:

Supports a new interface with SMF for exchanging the new Nausf_SMAuthentication_Authenticate Request/Response messages for primary authentication of the UE via non-integerated non-3GPP access (e.g., WLAN).

UE:

Capability indication of support for non-integrated non-3GPP access (e.g., WLAN) towards the 5GC.

Support for ATSSS using MPQUIC towards UPF without N3IWF/TNGF, using separate MPQUIC proxy address for 3GPP and non-3GPP accesses.

The methods and apparatus described herein allow a UE, e.g. UE 724, to access a 5G network, e.g., the 5G network including 5GC 702, via a WLAN AP (e.g., non-integrated non-3GPP access, e.g., non-integrated non-3GPP access network 708, without the use of N3IWF or TNGF) and transfer application data via a 3GPP 5G network (i.e., UE 724 to/from UPF 738 to/from data network (DN) 706). This access does not require the presence of a 3GPP network, e.g. 3GPP access network 716

A network operator, e.g., network operator A corresponding to 5GC 702, can, and in some embodiments does, make use of methods and apparatus, in accordance with the present invention, allowing the UE, e.g., UE 724, to initiate and maintain 5G service via this non-integrated non-3GPP access, e.g., non-integrated non-3GPP access network 708, with and without the presence of a 3GPP access, e.g., 3GPP access network 716.

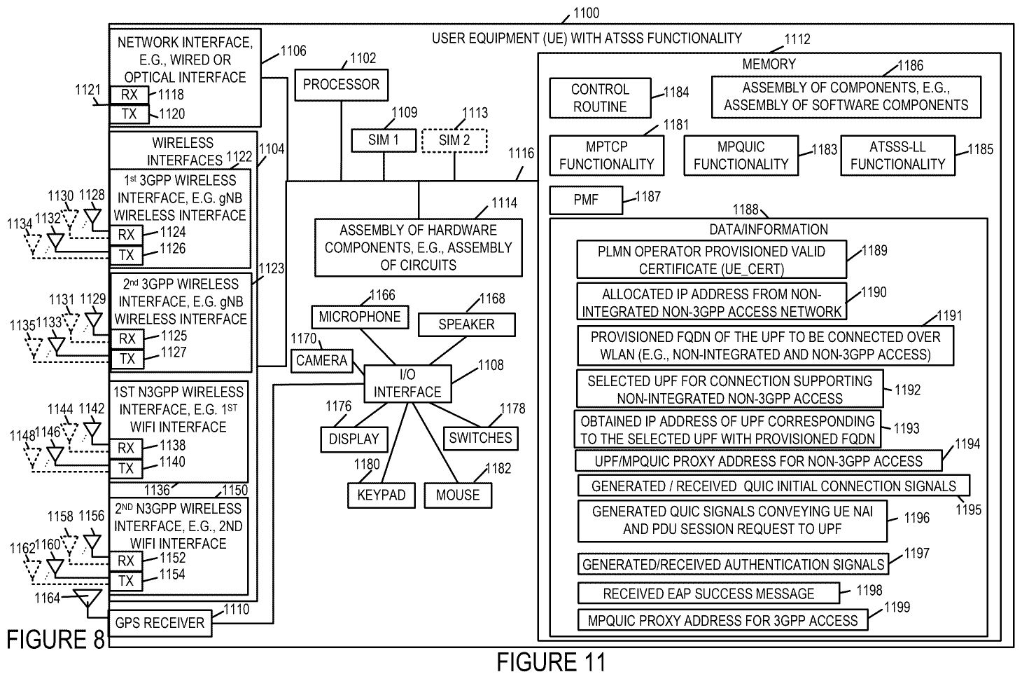

FIG. 11 illustrates an exemplary user equipment (UE) 1100, in accordance with the present invention, which can be used as the UE device in either of the FIG. 9 or FIG. 10 embodiments. UE 1100 is, e.g., any of the UEs of system 701 of FIG. 8, UE 724 of FIG. 9 and/or UE 724 of FIG. 10. Exemplary UE 1100 includes a processor 1102, e.g., a CPU, wireless interfaces 1104, a network interface 1106, I/O interface 1108, subscriber identity module 1 (SIM 1) 1109, GPS receiver 1110, memory 1112 and assembly of hardware components 1114, e.g., an assembly of circuits, coupled together via a bus 1116 over which the various elements may interchange data and information. Wireless interfaces 1104 includes a 1st 3GPP wireless interface 1122, e.g., a first gNB wireless interface, a 1st N3GPP wireless interface 1136, e.g., a 1st WiFi interface, and a 2nd N3GPP wireless interface 1150, e.g., a 2nd WiFi interface. In some embodiments, e.g., an embodiment in which UE 1100 is a DSDS UE, UE 1100 further includes a second SIM, SIM 2 1113, and wireless interfaces 1104 further includes 2nd 3GPP wireless interface 1123, e.g., a 2nd gNB wireless interface.

UE 1100 further includes a plurality of I/O devices (microphone 1166, speaker 1168, camera 1170, display 1176, e.g., a touchscreen display, switches 1178, keypad 1180 and mouse 1182) which are coupled to I/O interface 1108 via which the various I/O devices may communicate with other elements in UE 1100.

1st 3GPP wireless interface 1122 includes a wireless receiver 1124 and a wireless transmitter 1126. Wireless receiver 1124 is coupled to one or more receive antennas or antenna elements (1128, . . . , 1130) via which the UE 1100 receives wireless signals from a 3GPP radio access network, e.g., a base station. Wireless transmitter 1126 is coupled to one or more transmit antennas or antenna elements (1132, . . . , 1134) via which the UE 1100 transmits wireless signals to a 3GPP radio access network, e.g., a base station. 2nd 3GPP wireless interface 1123 includes a wireless receiver 1125 and a wireless transmitter 1127. Wireless receiver 1125 is coupled to one or more receive antennas or antenna elements (1129, . . . , 1131) via which the UE 1100 receives wireless signals from a 3GPP radio access network, e.g., a base station. Wireless transmitter 1127 is coupled to one or more transmit antennas or antenna elements (1133, . . . , 1135) via which the UE 1100 transmits wireless signals to a 3GPP radio access network, e.g., a base station.

1st N3GPP wireless interface 1136 includes a wireless receiver 1138 and a wireless transmitter 1140. Wireless receiver 1138 is coupled to one or more receive antennas or antenna elements (1142, . . . , 1144) via which the UE 1100 receives wireless signals from a N3GPP radio access network, e.g., a WiFi AP. Wireless transmitter 1140 is coupled to one or more transmit antennas or antenna elements (1146, . . . , 1148) via which the UE 1100 transmits wireless signals to a N3GPP radio access network, e.g., a WiFi AP. 2nd N3GPP wireless interface 1150 includes a wireless receiver 1152 and a wireless transmitter 1154. Wireless receiver 1152 is coupled to one or more receive antennas or antenna elements (1156, . . . , 1158) via which the UE 1100 receives wireless signals from a N3GPP radio access network, e.g., a WiFi AP. Wireless transmitter 1154 is coupled to one or more transmit antennas or antenna elements (1160, 1162) via which the UE 1100 transmits wireless signals to a N3GPP radio access network, e.g., a WiFi AP.

Network interface 1106, e.g., a wired or optical interface, includes a receiver 1118, transmitter 1120 and connector 1121. Network interface 1106 may be, and sometimes is, used by UE 1100 to couple UE 1100 to other network devices when the UE 1100 is located at a fixed location, in which the UE 1100 may be coupled to a wired or optical interface.

GPS receiver 1110 is coupled to GPS receiver antenna 1164 via which the UE 1100 receives GPS signals, which are used by GPS receiver 1110 to determine time, position, e.g., latitude, longitude and altitude, and velocity information.

SIM 1 1109 includes a first set of subscriber information corresponding to a first service provider, e.g., service provider A. SIM 2 1113 includes a second set of subscriber information corresponding to a second service provider, e.g., service provider B.

Memory 1112 includes control routine 1184, assembly of components 1186, MPTCP functionality 1181, MPQUIC functionality 1183, ATSSS-LL functionality 1185, PMF 1187 and data/information 1188. Control routine 1184 includes instructions which when executed by processor 1102 controls the UE 1100 to implement basic operational functions, e.g., read memory, write to memory, control an interface, load a program, subroutine, or app, etc. Assembly of components 1186, e.g., an assembly of software components, e.g., routines, subroutines, applications, etc., includes, e.g., code, e.g., machine executable instructions, which when executed by processor 1102, controls UE 1100 to implement steps of a method, e.g., steps of the method of signaling diagram 800 of FIG. 9 performed by UE 724, and/or steps of the signaling diagram 900 of FIG. 10 performed by UE 724.

Data/information 1188 includes a PLMN operator provisioned valid certificate (UE_CERT) 1189, an allocated IP address 1190 from a non-integrated non-3GPP access network, a provisioned FQDN (fully qualified domain name) 1191 of a UPF (which supports non-integrated non-3GPP access in accordance with features of the present invention) which UE 1100 is to to be connected over WLAN (e.g., non-integrated and non-3GPP access), information 1192 identifying a selected UPF (e.g., corresponding to the provisioned FQDN) to be used for a connection supporting non-integrated non-3GPP access, an obtained IP address 1193 of the UPF corresponding to the selected UPF, said UPF address being obtained via a DNS based on the provisioned FQDN, an obtained UPF/MPQUIC proxy address 1194 for non-integrated non-3GPP access, generated/received QUIC initial connection signals 1195, generated QUIC signals 1196 conveying UE NAI (network access identifier) and a PDU session request to UPF, generated/received authentication signals 1197, a received EAP success message 1198 and an MPQUIC proxy address for 3GPP access 1199.

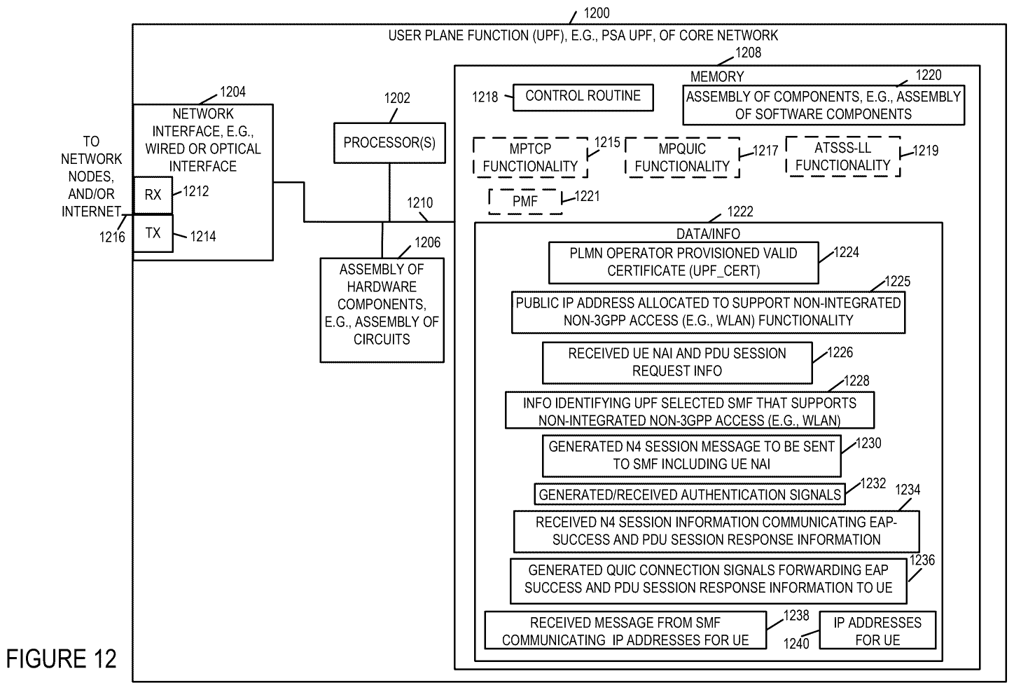

FIG. 12 is an exemplary user plane function (UPF), e.g., a PSA UPF, of a core network, e.g., a 5G PLMN core network, in accordance with an exemplary embodiment. UPF 1200 is, e.g., UPF 738 of FIGS. 8, 9 and/or 10.

UPF 1200 includes processor 1202, e.g., a CPU, network interface 1204, assembly of hardware components 1206, e.g., an assembly of circuits, and memory 1208 coupled together via bus 1210 over which the various elements may interchange data and information. Network interface 1204, e.g., a wired or optical interface, includes receiver 1212, transmitter 1214 and connector 1216. UPF 1200 is coupled to other network nodes, e.g., core network nodes, base stations, access points, data networks, and/or the Internet via network interface 1204.

Memory 1208 includes control routine 1218, assembly of components 1220, e.g., an assembly of software components, MPTCP functionality 1215, MPQUIC functionality 1217, ATSSS-LL functionality 1219, PMF 1221 and data/information 1222. Control routine 1218 includes instructions which when executed by processor 1202 controls the UPF 1200 to implement basic operational functions, e.g., read memory, write to memory, control an interface, load a program, subroutine, or app, etc. Assembly of components 1220, e.g., an assembly of software components, e.g., routines, subroutines, applications, etc., includes, e.g., code, e.g., machine executable instructions, which when executed by processor 1202, controls the UPF 1200 to implement steps of a method, e.g., steps of the method of signaling diagram 800 of FIG. 9 performed by UPF 738 and/or steps of the signaling diagram 900 of FIG. 10 performed by UPF 738.

Data/information 1222 includes a PLMN operator provisioned valid certificate (UPF_cert) 1224, a public IP address 1225 allocated to support non-integrated non-3GPP access (e.g., WLAN) functionality, received UE NAI and PDU session information 1126, which was received via a non-integrated non-3GPP access network, information 1228 identifying a UPF selected SMF that supports non-integrated non-3GPP access, e.g., WLAN, a generated N4 session message 1230 to be sent to SMF, said message including the UE NAI, generated/received authentication signals 1232, received N4 session information communicating EAP success and PDU session response information 1234, generated QUIC connection signals 1236 forwarding the received EAP success indication and the received PDU session response information to the UE, received message 1238 from SMF communicating IP addresses for UE, and stored received IP addresses for UE 1240.

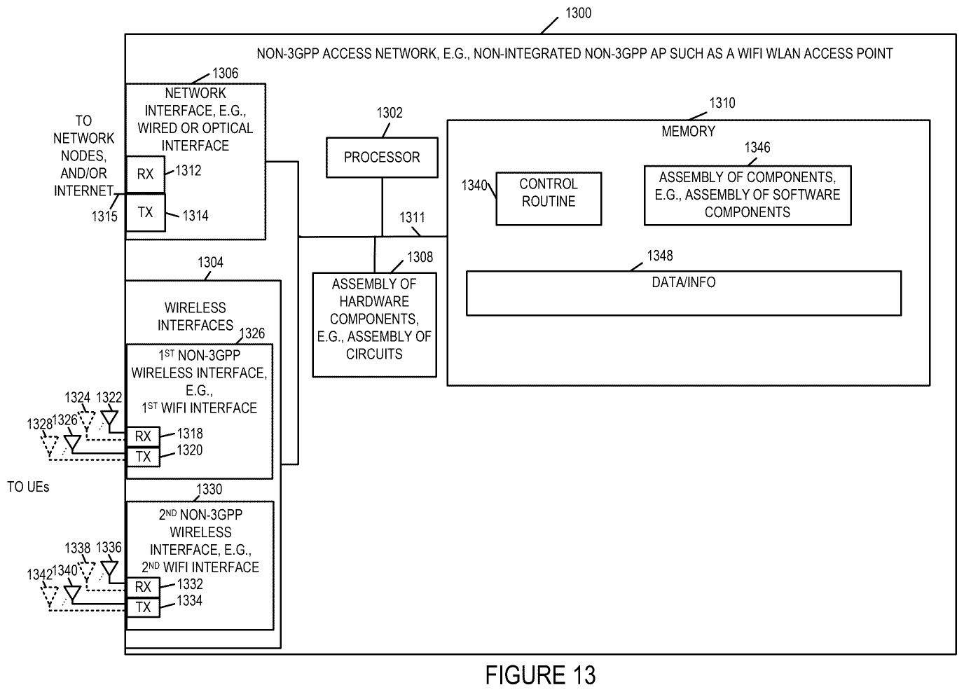

FIG. 13 is a drawing of an exemplary non-3GPP access network 1300, e.g., a non-integrated non-3GPP access point (AP) such as a WiFi WLAN access point, in accordance with the present invention. Non-3GPP access network 1300 is, e.g., non-integrated non-3GPP access network 708 of FIG. 8, FIG. 9 and FIG. 10.

Non-3GPP access network 1300 includes a processor 1302, e.g., a CPU, wireless interfaces 1304, network interface 1306, assembly of hardware components 1308, e.g., an assembly of circuits, and memory 1310 coupled together via a bus 1311 over which the various elements may interchange data and information. Wireless interfaces 1304 includes 1st non-3GPP wireless interface 1326, e.g., a 1st WiFi interface, and 2nd non-3GPP wireless interface 1330, e.g., a 2nd WiFi interface.

1st non-3GPP wireless interface 1326 includes wireless receiver 1318 and wireless transmitter 1320. Wireless receiver 1318 is coupled to one or more antennas or antenna elements (1322, . . . , 1324), via which non-3GPP access network 1300 receives wireless signals, e.g., WiFi wireless signals, from UE devices. Wireless transmitter 1320 is coupled to one or more antennas or antenna elements (1326, . . . , 1328), via which non-3GPP access network 1300 transmits wireless signals, e.g., WiFi wireless signals, to UE devices. 2nd non-3GPP wireless interface 1330 includes wireless receiver 1332 and wireless transmitter 1334. Wireless receiver 1332 is coupled to one or more antennas or antenna elements (1336, . . . , 1338), via which non-3GPP access network 1300 receives wireless signals, e.g., WiFi wireless signals, from UE devices. Wireless transmitter 1334 is coupled to one or more antennas or antenna elements (1340, . . . , 1342), via which non-3GPP access network 1300 transmits wireless signals, e.g., WiFi wireless signals, to UE devices. In some embodiments, 1st non-3GPP wireless interface 1326 and 2nd non-3GPP wireless interface 1330 correspond to different communications bands and/or different communications protocols.

Network interface 1306, e.g., a wired or optical interface, includes receiver 1312, transmitter 1314 and connector 1315. Non-3GPP access network 1300 is coupled to other network nodes, e.g., other access network nodes, e.g., other WiFi APs, core network nodes, and/or the Internet via network interface 1306.

Memory 1310 includes control routine 1340, assembly of components 1346, e.g., an assembly of software components, and data/information 1348. Control routine 1340 includes instructions which when executed by processor 1302 controls the non-3GPP access network 1300 to implement basic operational functions, e.g., read memory, write to memory, control an interface, load a program, subroutine, or app, etc. Assembly of components 1346, e.g., an assembly of software components, e.g., routines, subroutines, applications, etc., includes, e.g., code, e.g., machine executable instructions, which when executed by processor 1302, controls non-3GPP access network 1300 to implement steps of a method, e.g., steps of the method of signaling diagram 800 of FIG. 9 performed by non-integrated non-3GPP access network 708, and/or steps of the signaling diagram 900 of FIG. 10 performed by non-integrated non-3GPP access network 708.

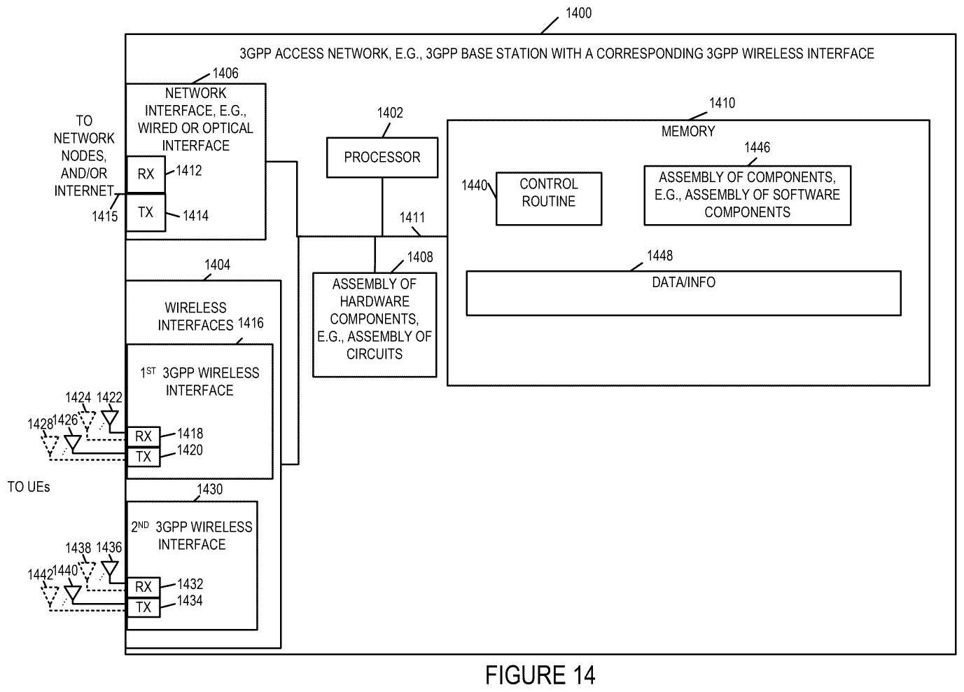

FIG. 14 is a drawing of an exemplary 3GPP access network 1400, e.g., a 3GPP base station, e.g., a gNB base station, with a corresponding 3GPP wireless interface, in accordance with the present invention. 3GPP access network 1400 is, e.g., 3GPP access network 716 of FIG. 9 and FIG. 10.

3GPP access network 1400 includes a processor 1402, e.g., a CPU, wireless interfaces 1404, network interface 1406, assembly of hardware components 1408, e.g., an assembly of circuits, and memory 1410 coupled together via a bus 1411 over which the various elements may interchange data and information. Wireless interfaces 1404 includes 1st 3GPP wireless interface 1416 and 2nd 3GPP wireless interface 1430.

3GPP wireless interface 1126 includes wireless receiver 1418 and wireless transmitter 1420. Wireless receiver 1418 is coupled to one or more antennas or antenna elements (1422, . . . , 1424), via which 3GPP access network 1400 receives wireless signals, e.g., cellular uplink wireless signals, from UE devices. Wireless transmitter 1420 is coupled to one or more antennas or antenna elements (1426, . . . , 1428), via which 3GPP access network 1400 transmits wireless signals, e.g., cellular downlink wireless signals, to UE devices. 2nd 3GPP wireless interface 1430 includes wireless receiver 1432 and wireless transmitter 1434. Wireless receiver 1432 is coupled to one or more antennas or antenna elements (1436, . . . , 1438), via which 3GPP access network 1400 receives wireless signals, e.g., cellular uplink wireless signals, from UE devices. Wireless transmitter 1434 is coupled to one or more antennas or antenna elements (1440, . . . , 1442), via which 3GPP access network 1400 transmits wireless signals, e.g., cellular wireless signals, to UE devices. In some embodiments, 1st 3GPP wireless interface 1416 and 2nd 3GPP wireless interface 1430 correspond to different communications bands and/or different communications protocols.

Network interface 1406, e.g., a wired or optical interface, includes receiver 1412, transmitter 1414 and connector 1415. 3GPP access network 1400 is coupled to other network nodes, e.g., other access network nodes, e.g., other base stations, core network nodes, and/or the Internet via network interface 1406.

Memory 1410 includes control routine 1440, assembly of components 1446, e.g., an assembly of software components, and data/information 1448. Control routine 1440 includes instructions which when executed by processor 1402 controls the 3GPP access network 1400 to implement basic operational functions, e.g., read memory, write to memory, control an interface, load a program, subroutine, or app, etc. Assembly of components 1446, e.g., an assembly of software components, e.g., routines, subroutines, applications, etc., includes, e.g., code, e.g., machine executable instructions, which when executed by processor 1402, controls 3GPP access network 1400 to implement steps of a method, e.g., steps of the method of signaling diagram 800 of FIG. 9 performed by 3GPP access network 716, and/or steps of the signaling diagram 900 of FIG. 10 performed by 3GPP access network 716.

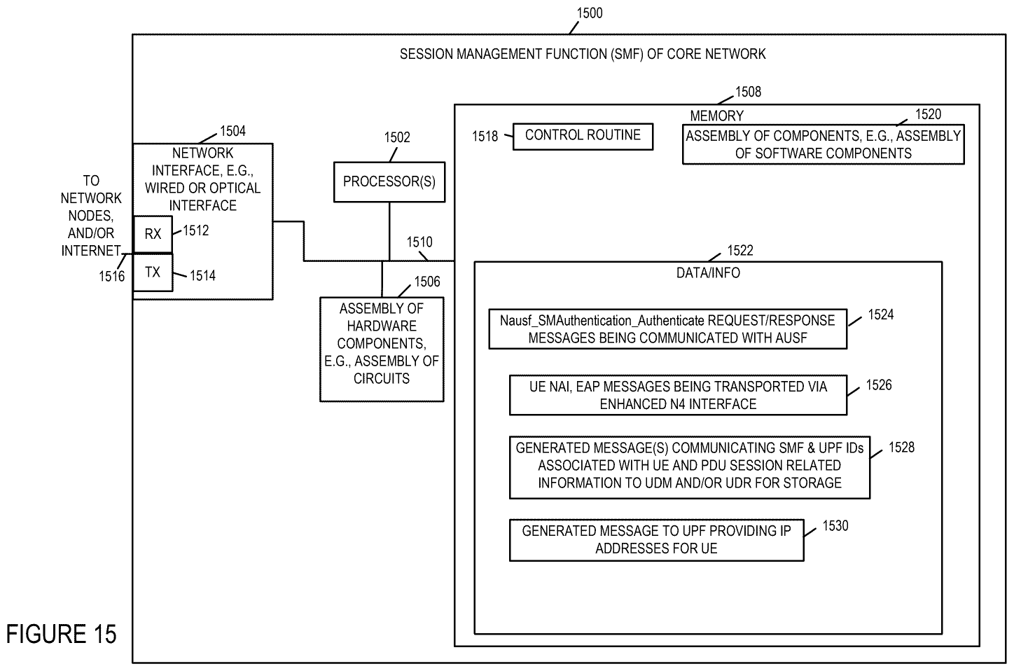

FIG. 15 is an exemplary session management function (SMF) 1500 of a core network, e.g., a 5G PLMN core network, in accordance with an exemplary embodiment. SMF 1500 is, e.g., SMF 734 of FIGS. 8, 9 and/or 10.

SMF 1500 includes processor 1502, e.g., a CPU, network interface 1504, assembly of hardware components 1506, e.g., an assembly of circuits, and memory 1508 coupled together via bus 1510 over which the various elements may interchange data and information. Network interface 1504, e.g., a wired or optical interface, includes receiver 1512, transmitter 1514 and connector 1516. SMF 1500 is coupled to other network nodes, e.g., core network nodes, base stations, access points and/or the Internet via network interface 1504.

Memory 1508 includes control routine 1518, assembly of components 1520, e.g., an assembly of software components, and data/information 1522. Control routine 1518 includes instructions which when executed by processor 1502 controls the SMF 1500 to implement basic operational functions, e.g., read memory, write to memory, control an interface, load a program, subroutine, or app, etc. Assembly of components 1520, e.g., an assembly of software components, e.g., routines, subroutines, applications, etc., includes, e.g., code, e.g., machine executable instructions, which when executed by processor 1502, controls the SMF 1500 to implement steps of a method, e.g., steps of the method of signaling diagram 800 of FIG. 9 performed by SMF 734 and/or steps of the signaling diagram 900 of FIG. 10 performed by SMF 734.

Data/information 1522 includes Nausf_SMAuthentication_Authentiate request and response messages being communicated between SMF 1500 and an AUSF, UE NAI, EAP messages 1526 being transported via an enhanced N4 interface, generated message(s) 1528 communicating SMF & UPF IDs associated with UE and PDU session related information to UDM and/or UDR for storage, and a generated message 1530 to be sent to UPF providing addresses for the UE.

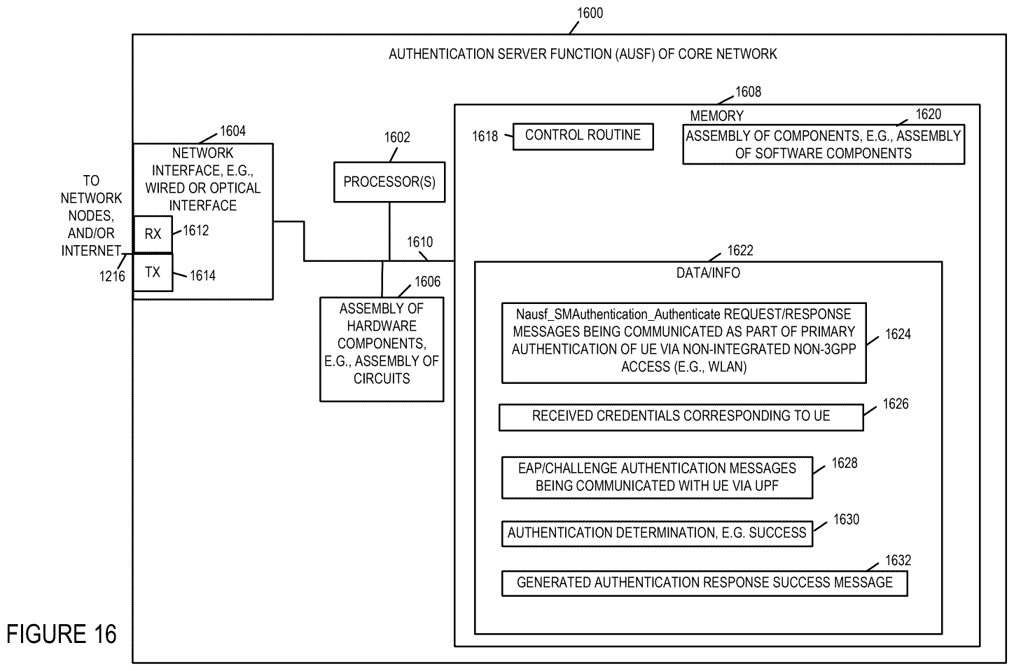

FIG. 16 is an exemplary authentication server function (AUSF) 1600 of a core network, e.g., a 5G PLMN core network, in accordance with an exemplary embodiment. AUSF 1600 is, e.g., AUSF 737 of FIGS. 8, 9 and/or 10.

AUSF 1600 includes processor 1602, e.g., a CPU, network interface 1604, assembly of hardware components 1606, e.g., an assembly of circuits, and memory 1608 coupled together via bus 1610 over which the various elements may interchange data and information. Network interface 1604, e.g., a wired or optical interface, includes receiver 1612, transmitter 1614 and connector 1616. AUSF 1600 is coupled to other network nodes, e.g., core network nodes, base stations, access points and/or the Internet via network interface 1604.

Memory 1608 includes control routine 1618, assembly of components 1620, e.g., an assembly of software components, and data/information 1622. Control routine 1618 includes instructions which when executed by processor 1602 controls the AUSF 1600 to implement basic operational functions, e.g., read memory, write to memory, control an interface, load a program, subroutine, or app, etc. Assembly of components 1620, e.g., an assembly of software components, e.g., routines, subroutines, applications, etc., includes, e.g., code, e.g., machine executable instructions, which when executed by processor 1602, controls the AUSF 1600 to implement steps of a method, e.g., steps of the method of signaling diagram 800 of FIG. 9 performed by AUSF 737 and/or steps of the signaling diagram 900 of FIG. 10 performed by AUSF 737.

Data/information 1622 includes Nausf_SMAuthentication_Authenticate request and response messages 1624 being communicated as part of a primary authentication of a UE via non-integrated non-3GPP access, e.g. WLAN, received credential 1626 corresponding to a UE, EAP/challenge authentication messages 1628 being communicated with UE via UPF, an authentication determination 1630, e.g. a success determination, and a generated authentication response success message 1632.

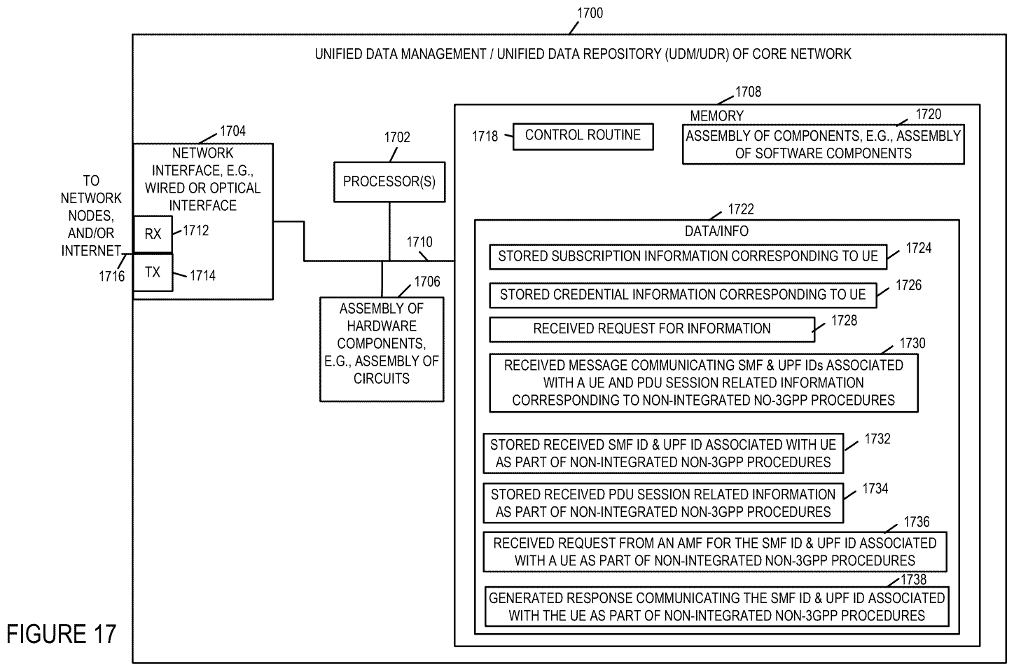

FIG. 17 is an exemplary unified data management or unified data repository (UDM/UDR) 1700 of a core network, e.g., a 5G PLMN core network, in accordance with an exemplary embodiment. UDM/UDR 1700 is, e.g., UDM 740 of FIGS. 8, 9 and/or 10 or UDR 741 of FIGS. 8, 9 and/or 10.

UDM/UDR 1700 includes processor 1702, e.g., a CPU, network interface 1704, assembly of hardware components 1706, e.g., an assembly of circuits, and memory 1708 coupled together via bus 1710 over which the various elements may interchange data and information. Network interface 1704, e.g., a wired or optical interface, includes receiver 1712, transmitter 1714 and connector 1716. UDM/UDR 1700 is coupled to other network nodes, e.g., core network nodes, base stations, access points and/or the Internet via network interface 1704.

Memory 1708 includes control routine 1718, assembly of components 1720, e.g., an assembly of software components, and data/information 1722. Control routine 1718 includes instructions which when executed by processor 1702 controls the UDM/UDR 1700 to implement basic operational functions, e.g., read memory, write to memory, control an interface, load a program, subroutine, or app, etc. Assembly of components 1720, e.g., an assembly of software components, e.g., routines, subroutines, applications, etc., includes, e.g., code, e.g., machine executable instructions, which when executed by processor 1702, controls the UDM/UDR 1700 to implement steps of a method, e.g., steps of the method of signaling diagram 800 of FIG. 9 performed by UDM 740 or UDR 741 and/or steps of the signaling diagram 900 of FIG. 10 performed by UDM 740 or UDR 741. Data/information 1722 includes stored subscription information 1724 corresponding to a UE, stored credential information 1726 corresponding to a UE, a received request 1728 for information, e.g. subscription and/or credential information, a received message 1730 communicating SMF & UPF IDs associated with a UE and PDU session related information corresponding to non-integrated non-3GPP procedures, stored received SMF ID & UPF IDs 1732 associated with the UE as part of non-integrated non-3GPP procedures, stored received PDU session related information 1734, which were stored as part of non-integrated non-3GPP procedures, a received request 1736 from an AMF requesting the stored SMF & UPF IDs associated with a UE corresponding to non-integrated non-3GPP procedures, and a generated response message 1738 to be sent to the AMF, said response message 1738 communicating the SMF & UPF IDs associated with the UE corresponding to non-integrated non-3GPP procedures.

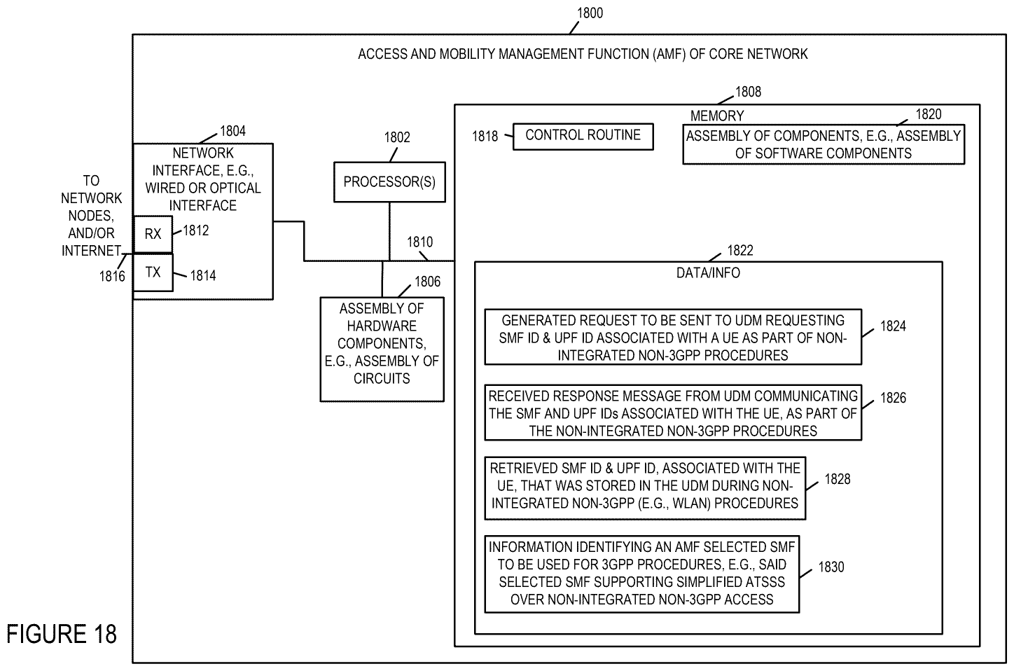

FIG. 18 is an exemplary access and mobility management function (AMF) 1800 of a core network, e.g., a 5G PLMN core network, in accordance with an exemplary embodiment. AMF 1800 is, e.g., AMF 732 of FIGS. 8, 9 and/or 10.

AMF 1800 includes processor 1802, e.g., a CPU, network interface 1804, assembly of hardware components 1806, e.g., an assembly of circuits, and memory 1808 coupled together via bus 1810 over which the various elements may interchange data and information. Network interface 1804, e.g., a wired or optical interface, includes receiver 1812, transmitter 1814 and connector 1816. AMF 1800 is coupled to other network nodes, e.g., core network nodes, base stations, access points and/or the Internet via network interface 1804.

Memory 1808 includes control routine 1818, assembly of components 1820, e.g., an assembly of software components, and data/information 1822. Control routine 1818 includes instructions which when executed by processor 1802 controls the AMF 1800 to implement basic operational functions, e.g., read memory, write to memory, control an interface, load a program, subroutine, or app, etc. Assembly of components 1820, e.g., an assembly of software components, e.g., routines, subroutines, applications, etc., includes, e.g., code, e.g., machine executable instructions, which when executed by processor 1802, controls the AMF 1800 to implement steps of a method, e.g., steps of the method of signaling diagram 800 of FIG. 9 performed by AMF 732 and/or steps of the signaling diagram 900 of FIG. 10 performed by AMF 732. Data/information 1822 includes a generated request 1824 to be sent to UDM requesting SMF ID and UPF ID associated with a UE as part of non-integrated non-3GPP procedures, a received response message 1826 from UDM communicating the SMF and UPF IDs associated with the UE, as part of the non-integrated non-3GPP procedures, information 1828 included the retrieved SMF ID and UPF ID, associated with the UE, that was stored in the UDM during the non-integrated non-3GPP (e.g., WLAN) procedures, and information 1830 identifying an AMF selected SMF to be used for 3GPP procedures for the UE, e.g., said selected SMF supporting simplified ATSSS over non-integrated non-3GPP access. In some embodiments, the selected SMF identified in information 1830 is the same SMF identified in information 1828.

### Numbered List of Exemplary Method Embodiments

Method Embodiment 1. A communications method comprising: storing (9041) (e.g., a public land mobile network (PLMN) operator provisions in step 904) a certificate (e.g., a valid certificate) corresponding to a user plane function (UPF) (738) in the UPF (738) of a network core (702) (e.g., a 5G PLMN core); operating the UPF (738) to use (915) the stored certificate corresponding to the UPF to establish a secure connection between a first user equipment (UE) (724) and the UPF (738) (e.g., a QUIC connection which is based on a security handshake and/or mutual authentication procedure which relies on a stored certificate in the first UE (724) corresponding to the first UE (724) to authenticate the first UE (724) to the UPF (738) and a stored certificate in the UPF (738) to authenticate the UPF (738) to the first UE (708), where the secure connection is between the first UE (724) and UPF (738) and traverses a non-integrated non-3GPP access network (708)); and operating an authentication server function (AUSF) (737) included in the network core (702) to perform (984) an Extensible Authentication Protocol (EAP) authentication procedure to authenticate the first UE based on information (e.g., EAP/Challenge) communicated via the secure communication connection (e.g., as part of a UE authentication procedure (973) with the network core) (e.g., wherein the secure connection was established between the first UE 724 and UPF 738).

Method Embodiment 2. The method of Method Embodiment 1, wherein using (915) the stored certificate corresponding to the UPF (738) to establish a secure connection involves communicating crypto key information (see, e.g., steps 920 and 932 of FIG. 10) as part of a handshake between the first UE (724) and UPF (738) (e.g., with the crypto key information being communicated via the non-integrated non-3GPP access network which in some cases is a WLAN).

Method Embodiment 3. The method of Method Embodiment 1, further comprising: operating the UPF (738) to select (934) a first session management function (SMF) (734) in the network core (702) to provide service to the first UE (724); and operating the UPF (738) to send (936) a N4 Session message to the first SMF (734), said N4 session message includes a first UE NAI (Network Access Identifier) corresponding to the first UE (724) and Protocol Data Unit (PDU) Session request related information.

Method Embodiment 4. The method of Method Embodiment 3, further comprising: operating the first SMF (734) upon receiving (940) a N4 Session message from the UPF (738), to retrieve (942) UE subscription information from a unified data management (UDM) (740) or a unified data repository (UDR) (741) and initiate (947) the authentication process (e.g., when the UE subscription allows); operating the first SMF (734) to send (948) an authentication request including the first UE NAI to the AUSF (737) in the network core (702); operating (954) the AUSF (737) to retrieve UE credentials from the UDM (740) or the UDR (741) and to send (956) authentication response to the first SMF (734); and operating the first SMF (734) to send (962) N4 Session message to UPF (738) with authentication challenge (e.g. EAP/challenge).

Method Embodiment 4A. The method of Method Embodiment 4, further comprising: operating the UPF (738) to forward (968) the EAP/challenge from first SMF (734) to the first UE (724) in a secure QUIC connection (e.g., encrypted message).

Method Embodiment 5. The method of Method Embodiment 4, wherein operating the AUSF (737) to perform (984) an EAP authentication procedure to authenticate the first UE (724), includes communicating a challenge to the first UE (724) over the secure connection between the UPF (738) to the UE (724), said challenge being from the AUSF (737).

Method Embodiment 6. The method of Method Embodiment 4, further comprising: operating the first SMF (734), following successful authentication of the first UE (724) (e.g., in step 985), to receive (990) an indication of the successful authentication and optionally to initiate (992) Session Management (SM) Policy Association Establishment or Modification with a first policy control function (PCF) (716); and operating the first SMF (734), following successful authentication of the first UE (724) (e.g., in step 985) and optionally completing (992) SM Policy Association Establishment or Modification with the first PCF (716), to communicate (998) PDU session related information corresponding to the first UE (724) to the UPF (738).

Method Embodiment 7. The method of Method Embodiment 6, further comprising: operating the UPF (738) to communicate (1004) authentication success and PDU session related information to the first UE (724) over the secure communications connection between the UPF (738) and first UE (724); and operating the first SMF (734) to send (1010) UPF ID and SMF ID associated with first UE (724) to the UDM (740) or UDR (741) for storage.

Method Embodiment 7A. The method of Method Embodiment 7, further comprising: operating the UDM (740) to receive (1014) the UPF ID and SMF ID associated with the first UE (724); and operating the UDM (740) to store (1016) the received UPF ID and SMF ID associated with the first UE (724) in the UDM (740).

Method Embodiment 7B. The method of Method Embodiment 7, further comprising: operating the UDR (741) to receive (1015) the UPF ID and SMF ID associated with the first UE (724); and operating the UDR (741) to store (1018) the received UPF ID and SMF ID associated with the first UE (724) in the UDR (741).

Method Embodiment 8. The method of Method Embodiment 7, further comprising: communicating (1034) application data over the secure communication connection between the first UE (724) and UPF (738) via a non-integrated non-3GPP access network (708) (e.g., WLAN).

Method Embodiment 9. The method of Method Embodiment 8, further comprising: operating the network core (702) to perform (1038) a 3rd Generation Partnership Project (3GPP) registration and PDU Session establishment procedure with the first UE (724) via a 3GPP access network (716); and operating the first access and mobility management function (AMF) (732) to retrieve (1046, 1070) the SMF ID, UPF ID that was stored (e.g., in step 1016) in the UDM (740) during the non-integrated non-3GPP (e.g., WLAN) procedures (910).

Method Embodiment 9A. The method of Method Embodiment 9, further comprising: operating the first AMF (732) to select (1074) the first SMF (734) corresponding to the retrieved SMF ID to be used for the 3GPP session being established for the first UE (724).

Method Embodiment 9B. The method of Method Embodiment 1, wherein the retrieval and use of information from the UDM (740) corresponding to the first UE (724) facilitates convergence of the data flow for the first UE (724) across both 3GPP access (716) and non-3GPP access (708).

Method Embodiment 10. The method of Method Embodiment 9, wherein said 3GPP registration and PDU Session establishment procedure establishes a PDU Session with the network core (702) via the 3GPP access network (716).

Method Embodiment 11. The method of Method Embodiment 10, wherein the PDU Session with the network core (702) via the 3GPP access network (716) is established following the establishment of the PDU Session between the first UE (724) and network core (702) via the non-integrated non-3GPP access network (708) and wherein both the session via the non-integrated non-3GPP access network (708) and 3GPP access network (716) are ongoing at the same time allowing data traffic to use ATSSS features (e.g., steer, switch, and split of traffic) between the two alternative connections to the network core (702).

Method Embodiment 12. The method of Method Embodiment 11, wherein the first UE (724) supports ATSSS using MPQUIC toward UPF, without a N3IWF and/or a TNGF, using a separate MPQUIC proxy address for 3GPP and non-3GPP access.

Method Embodiment 13. The method of Method Embodiment 1, further comprising: operating the first UE (724) to perform (973) a UE authentication procedure with the network core (702) (e.g., with an AUSF (737) included in the network core (702)) via the secure connection.

Method Embodiment 14. The method of Method Embodiment 1, further comprising: operating (908) the first UE (724) to obtain the Internet Protocol (IP) address of the UPF (738) (e.g., the network operator provides the UPF IP address to the first UE (724)) prior to operating the UPF (738) to use (915) the stored certificate to establish the secure communications connection between the first UE (724) and UPF (738).

Method Embodiment 15. The method of Method Embodiment 4, wherein the UDM function is a 5G centralized repository and management entity for user-related data (which is also sometimes referred to as a user data management function).

Method Embodiment 16. The method of Method Embodiment 4, wherein the UPF (738) and UDM (740) are components of a 5G network core (702) of a PLMN operator which provides service to the first UE (724).

Method Embodiment 17. The method of Method Embodiment 14, wherein the first UE (724) is pre-provisioned with a UPF Fully Qualified Domain Name (FQDN) corresponding to a UPF which supports non-integrated non-3GPP access.

Method Embodiment 18. The method of Method Embodiment 17, wherein operating (908) the first UE (724) to obtain the IP address of the UPF (738) includes: sending (9084) a query (9085) including the pre-provisioned UPF FQDN to a Domain Name Server (DNS) (703); and receiving (9089) a response (9089) from the DNS (703) including the IP address of the UPF.

### Numbered List of Exemplary System Embodiments

System Embodiment 1. A communications system (700) comprising: a network core (702) (e.g., a 5G PLMN core) including: a user plane function (UPF) (738 or 1200) including a first processor (1202) and a first memory (1208); and an authentication server function (AUSF) (737 or 1600) including a second processor (1602); and wherein said first processor (1202) is configured to operate the UPF (738) to: store (7041) in said first memory (1208) a certificate (e.g., a valid certificate) corresponding to the user plane function (UPF) (738) (e.g., a public land mobile network (PLMN) operator provisions in step 904) a certificate (e.g., a valid certificate) corresponding to the user plane function (UPF) (738); use (915) the stored certificate corresponding to the UPF (738) to establish a secure connection between a first UE (724) and the UPF (738) (e.g., a QUIC connection which is based on a security handshake and/or mutual authentication procedure which relies on a stored certificate in the first UE (724) corresponding to the first user equipment (UE) (724) to authenticate the first UE (724) to the UPF (738) and a stored certificate in the UPF (738) to authenticate the UPF (738) to the first UE (708), where the secure connection is between the first UE (724) and UPF (738) and traverses a non-integrated non-3GPP access network (708)); and wherein said second processor (1602) is configured to operate the AUSF (737) to: perform (984) an Extensible Authentication Protocol (EAP) authentication procedure to authenticate the first UE based on information (e.g., EAP/Challenge) communicated via the secure communication connection (e.g., as part of a UE authentication procedure (973) with the network core) (e.g., wherein the secure connection was established between the first UE (724) and UPF (738)).

System Embodiment 2. The communications system of System Embodiment 1, wherein said first processor (1202) is configured to operate the UPF (738) to communicate crypto key information (see, e.g., steps 920 and 932 of FIG. 10) as part of a handshake between the first UE (724) and UPF (738) (e.g., with the crypto key information being communicated via the non-integrated non-3GPP access network which in some cases is a WLAN), as part of being configured to operate the UPF (738) to use (915) the stored certificate corresponding to the UPF (738) to establish a secure connection.

System Embodiment 3. The communications system of System Embodiment 1, wherein said first processor (1202) is further configured to: operate the UPF (738) to select (934) a first session management function (SMF) (734) in the network core (702) to provide service to the first UE (724); and operate the UPF (738) to send (936) a N4 Session message to the first SMF (734), said N4 session message includes a first UE NAI (Network Access Identifier) corresponding to the first UE (724) and Protocol Data Unit (PDU) Session request related information.

System Embodiment 4. The communications system of System Embodiment 3, wherein said network core (702) further includes said first session management function (SMF) (734 or 1500) including a third processor (1502) configured to: operate the first SMF (734) to receive a N4 Session message from the UPF (738); operate the first SMF (734), upon receiving (940) a N4 Session message from the UPF (738), to retrieve (942) UE subscription information from a unified data management (UDM) (740) or a unified data repository (UDR) (741) and initiate (947) the authentication process (e.g., when the UE subscription allows); and operate the first SMF (734) to send (948) an authentication request including the first UE NAI to the AUSF (737) in the network core (702); and wherein said second processor (1602) is further configured to: operate (954) the AUSF (737) to retrieve UE credentials from the UDM (740) or the UDR (741) and to send (956) authentication response to the first SMF (734); and wherein said third processor (1502) is further configured to: operate the first SMF (734) to send (962) N4 Session message to UPF (738) with authentication challenge (e.g. EAP/challenge).

System Embodiment 4A. The communications system of System Embodiment 4, wherein said first processor (1202) is further configured to: operate the UPF (738) to forward (968) the EAP/challenge from first SMF (734) to the first UE (724) in a secure QUIC connection (e.g., encrypted message).

System Embodiment 5. The communications system of System Embodiment 4, wherein said second processor (1602) is configured to: operate the AUSF (737) to communicate a challenge to be sent to the first UE (724) over the secure connection between the UPF (738) to the UE (724), as part of being configured to operate the AUSF (737) to perform (984) an EAP authentication procedure to authenticate the first UE (724), said challenge being from the AUSF (737).

System Embodiment 6. The communications system of System Embodiment 4, wherein said third processor (1502) is further configured to: operate the first SMF (734), following successful authentication of the first UE (724) (e.g., in step 985), to receive (990) an indication of the successful authentication and optionally to initiate (992) Session Management (SM) Policy Association Establishment or Modification with a first policy control function (PCF) (716); and operate the first SMF (734), following successful authentication of the first UE (724) (e.g., in step 985) and optionally completing (992) SM Policy Association Establishment or Modification with the first PCF (716), to communicate (998) PDU session related information corresponding to the first UE (724) to the UPF (738).

System Embodiment 7. The communications system of System Embodiment 6, wherein said first processor (1202) is further configured to: operate the UPF (738) to communicate (1004) authentication success and PDU session related information to the first UE (724) over the secure communications connection between the UPF (738) and first UE (724); and wherein said third processor (1502) is further configured to: operate the first SMF (734) to send (1010) UPF ID and SMF ID associated with first UE (724) to the UDM (740) or UDR (741) for storage.

System Embodiment 7A. The communications system of System Embodiment 7, wherein said network core (702) further includes a unified data management (740 or 1700) including a second memory (1708) and a fourth processor (1702) configured to: operate the UDM (740) to receive (1014) the UPF ID and SMF ID associated with the first UE (724); and operate the UDM (740) to store (1016), in said second memory (1708), the received UPF ID and SMF ID associated with the first UE (724).

System Embodiment 7B. The communications system of System Embodiment 7, wherein said network core (702) further includes a unified data repository (UDR) (741 or 1700) including second memory (1708) and a fourth processor (1702) configured to: operate the UDR (741) to receive (1015) the UPF ID and SMF ID associated with the first UE (724); and operate the UDR (741) to store (1018) the received UPF ID and SMF ID associated with the first UE (724) in said second memory (1708).

System Embodiment 8. The communications system of System Embodiment 7, wherein said UPF (738) includes a receiver (1212) and a transmitter (1214); and wherein said first processor (1202) is further configured to: operate the UPF (738) to communicate (1034) (via the receiver (1212) and transmitter (1214)) application data over the secure communication connection between the first UE (724) and UPF (738) via a non-integrated non-3GPP access network (708) (e.g., a WLAN such as a WiFi access point (AP)).

System Embodiment 9. The communications system of System Embodiment 8, wherein said network core (702) further includes a first access and mobility management function (AMF) (732 or 1800) including a fourth processor (1802); and wherein said the network core (702) is configured to perform (1038) a 3GPP registration and PDU Session establishment procedure with the first UE (724) via a 3GPP access network (716); and wherein said fourth processor (1802) is configured to operate the first AMF (732) to retrieve (1046, 1070) the SMF ID, UPF ID that was stored (e.g., in step 1016) in the UDM (740) during the non-integrated non-3GPP (e.g., WLAN) procedures (910).

System Embodiment 9A. The communications system of System Embodiment 9, wherein said fourth processor (1802) is further configured to: operate the first AMF (732) to select (1074) the first SMF (734) corresponding to the retrieved SMF ID to be used for the 3GPP session being established for the first UE (724).

System Embodiment 9B. The communications system of System Embodiment 1, wherein the retrieval and use of information from the UDM (740) corresponding to the first UE (724) facilitates convergence of the data flow for the first UE (724) across both 3GPP access (716) and non-3GPP access (708).

System Embodiment 10. The communications system of System Embodiment 9, wherein said 3GPP registration and PDU Session establishment procedure establishes a PDU Session with the network core (702) via the 3GPP access network (716).

System Embodiment 11. The communications system of System Embodiment 10, wherein the PDU Session with the network core (702) via the 3GPP access network (716) is established following the establishment of the PDU Session between the first UE (724) and network core (702) via the non-integrated non-3GPP access network (708) and wherein both the session via the non-integrated non-3GPP access network (708) and 3GPP access network (716) are ongoing at the same time allowing data traffic to use ATSSS features (e.g., steer, switch, and split of traffic) between the two alternative connections to the network core (702).

System Embodiment 12. The communications system of System Embodiment 11, wherein the first UE (724) supports ATSSS using MPQUIC toward UPF, without a N3IWF and/or a TNGF, using a separate MPQUIC proxy address for 3GPP and non-3GPP access.

System Embodiment 13. The communications system of System Embodiment 1, further comprising: said first UE (724 or 1100) including a third processor (1102) configured to: operate the first UE (724) to perform (973) a UE authentication procedure with the network core (702) (e.g., with an AUSF (737) included in the network core (702)) via the secure connection.

System Embodiment 14. The communications system of System Embodiment 1, wherein said third processor (1102) is further configured to: operate (908) the first UE (724) to obtain the IP address of the UPF (738) (e.g., the network operator provides the UPF IP address to the first UE (724)) prior to operating the UPF (738) to use (915) the stored certificate to establish the secure communications connection between the first UE (724) and UPF (738).

System Embodiment 15. The communications system of System Embodiment 4, wherein the UDM function (740) is a 5G centralized repository and management entity for user-related data (which is also sometimes referred to as a user data management function).

System Embodiment 16. The communications system of System Embodiment 4, wherein the UPF (738) and UDM (740) are components of a 5G network core (702) of a PLMN operator which provides service to the first UE (724).

System Embodiment 17. The communications system of System Embodiment 14, wherein the first UE (724) is pre-provisioned with a UPF Fully Qualified Domain Name (FQDN) corresponding to a UPF which supports non-integrated non-3GPP access.

System Embodiment 18. The communications system of System Embodiment 17, wherein said third processor (1202) is configured to: operate the first UE (724) to send (9084) a query (9085) including the pre-provisioned UPF FQDN to a Domain Name System (DNS) (703); and operate the first UE (724) to receive (9089) a response (9088) from the DNS including the IP address of the UPF (738), as part of being configured to operate (908) the first UE (724) to obtain the IP address of the UPF (738).

The techniques of various embodiments may be implemented using software, hardware and/or a combination of software and hardware. Various embodiments are directed to apparatus, e.g., user equipment (UE) devices, core network devices (e.g., PCF devices, AMF devices, SMF devices, UPF devices, UDM devices, UDR devices, AUSF devices, etc.), access network devices (e.g., WLAN APs, base stations, WiFi access nodes, cable network access devices), wireless devices, mobile devices, smartphones, subscriber devices, desktop computers, printers, IPTV, laptops, tablets, network edge devices, Access Points, wireless routers, switches, WLAN controllers, orchestration servers, orchestrators, Gateways, AAA servers, servers, nodes and/or elements. Various embodiments are also directed to methods, e.g., method of controlling and/or operating user equipment (UE) devices, core network devices (e.g., PCF devices, AMF devices, SMF devices, UPF devices, AUSF devices, UDM devices, UDR devices, etc.), access network devices (e.g., WLAN APs, base stations, WiFi access nodes, cable network access devices), wireless devices, mobile devices, smartphones, subscriber devices, desktop computers, printers, IPTV, laptops, tablets, network edge devices, Access Points, wireless routers, switches, WLAN controllers, orchestration servers, orchestrators, Gateways, AAA servers, servers, nodes and/or elements. Various embodiments are also directed to a machine, e.g., computer, readable medium, e.g., ROM, RAM, CDs, hard discs, etc., which include machine readable instructions for controlling a machine to implement one or more steps of a method. The computer readable medium is, e.g., non-transitory computer readable medium.

It is understood that the specific order or hierarchy of steps in the processes and methods disclosed is an example of exemplary approaches. Based upon design preferences, it is understood that the specific order or hierarchy of steps in the processes and methods may be rearranged while remaining within the scope of the present disclosure. The accompanying method claims present elements of the various steps in a sample order and are not meant to be limited to the specific order or hierarchy presented. In some embodiments, one or more processors are used to carry out one or more steps of each of the described methods.

In various embodiments each of the steps or elements of a method are implemented using one or more processors. In some embodiments, each of elements or steps are implemented using hardware circuitry.

In various embodiments devices, e.g., user equipment (UE) devices, core network devices (e.g., PCF devices, AMF devices, SMF devices, UPF devices, UDM devices, UDR devices, AUSF devices, etc.), access network devices (e.g., base stations, WLAN APs, WiFi access nodes, cable network access devices), wireless devices, mobile devices, smartphones, subscriber devices, desktop computers, printers, IPTV, laptops, tablets, network edge devices, Access Points, wireless routers, switches, WLAN controllers, orchestration servers, orchestrators, Gateways, AAA servers, servers, nodes and/or elements described herein are implemented using one or more components to perform the steps corresponding to one or more methods, for example, provisioning user equipment devices, provisioning AP devices, provisioning AAA servers, provisioning orchestration servers, generating messages, message reception, message transmission, signal processing, sending, comparing, determining and/or transmission steps. Thus, in some embodiments various features are implemented using components, or in some embodiments logic such as for example logic circuits. Such components may be implemented using software, hardware or a combination of software and hardware. Many of the above described methods or method steps can be implemented using machine executable instructions, such as software, included in a machine readable medium such as a memory device, e.g., RAM, floppy disk, etc. to control a machine, e.g., general purpose computer with or without additional hardware, to implement all or portions of the above described methods, e.g., in one or more devices, servers, nodes and/or elements. Accordingly, among other things, various embodiments are directed to a machine-readable medium, e.g., a non-transitory computer readable medium, including machine executable instructions for causing a machine, e.g., processor and associated hardware, to perform one or more of the steps of the above-described method(s). Some embodiments are directed to a device, e.g., a controller, including a processor configured to implement one, multiple or all of the steps of one or more methods of the invention.

In some embodiments, the processor or processors, e.g., CPUs, of one or more devices, e.g., user (UE) devices, core network devices (e.g., PCF devices, AMF devices, SMF devices, UPF devices, AUSF devices, UDM devices, UDR devices, etc.), access network devices (e.g., base stations, WLAN APs, WiFi access nodes, cable network access devices), wireless devices, mobile devices, smartphones, subscriber devices, desktop computers, printers, IPTV, laptops, tablets, network edge devices, Access Points, wireless routers, switches, WLAN controllers, orchestration servers, orchestrators, Gateways, AAA servers, servers, nodes and/or elements, are configured to perform the steps of the methods described as being performed by the user equipment devices, wireless devices, mobile devices, smartphones, subscriber devices, desktop computers, printers, IPTV, laptops, tablets, network edge devices, Access Points, wireless routers, switches, WLAN controllers, orchestration servers, orchestrators, Gateways, AAA servers, servers, nodes and/or elements. The configuration of the processor may be achieved by using one or more components, e.g., software components, to control processor configuration and/or by including hardware in the processor, e.g., hardware components, to perform the recited steps and/or control processor configuration. Accordingly, some but not all embodiments are directed to a device, e.g., a user equipment (UE) device, core network device (e.g., PCF device, AMF device, SMF device, UPF device, AUSF device, UDM device, UDR device, etc.), access network device (e.g., base station, WLAN AP, WiFi access node, cable network access device), wireless device, mobile device, smartphone, subscriber device, desktop computer, printer, IPTV, laptop, tablet, network edge device, Access Point, wireless router, switch, WLAN controller, orchestration server, orchestrator, Gateway, AAA server, server, node and/or element, with a processor which includes a component corresponding to each of the steps of the various described methods performed by the device in which the processor is included. In some but not all embodiments a device, e.g., user equipment (UE) devices, core network devices (e.g., PCF devices, AMF devices, SMF devices, UPF devices, AUSF devices, UDM devices, UDR devices, etc.), access network devices (e.g., base stations, WLAN APs, WiFi access nodes, cable network access devices), wireless devices, mobile devices, smartphones, subscriber devices, desktop computers, printers, IPTV, laptops, tablets, network edge devices, Access Points, wireless routers, switches, WLAN controllers, orchestration servers, orchestrators, Gateways, AAA servers, servers, nodes and/or elements, includes a controller corresponding to each of the steps of the various described methods performed by the device in which the processor is included. The components may be implemented using software and/or hardware.

Some embodiments are directed to a computer program product comprising a computer-readable medium, e.g., a non-transitory computer-readable medium, comprising code for causing a computer, or multiple computers, to implement various functions, steps, acts and/or operations, e.g., one or more steps described above. Depending on the embodiment, the computer program product can, and sometimes does, include different code for each step to be performed. Thus, the computer program product may, and sometimes does, include code for each individual step of a method, e.g., a method of controlling a device, e.g., user (UE) device, core network device (e.g., PCF device, AMF device, SMF device, UPF device, AUSF device, UDM device, UDR device, etc.), access network device (e.g., base station, WLAN AP, WiFi access node, cable network access device), wireless device, mobile device, smartphone, subscriber device, desktop computer, printer, IPTV, laptop, tablet, network edge device, Access Point, wireless router, switch, WLAN controller, orchestration server, orchestrator, Gateway, AAA server, server, nodes and/or element. The code may be in the form of machine, e.g., computer, executable instructions stored on a computer-readable medium, e.g., a non-transitory computer-readable medium, such as a RAM (Random Access Memory), ROM (Read Only Memory) or other type of storage device. In addition to being directed to a computer program product, some embodiments are directed to a processor configured to implement one or more of the various functions, steps, acts and/or operations of one or more methods described above. Accordingly, some embodiments are directed to a processor, e.g., CPU, configured to implement some or all of the steps of the methods described herein. The processor may be for use in, e.g., a communications device such as a user equipment (UE) device, core network device (e.g., PCF device, AMF device, SMF device, UPF device, AUSF device, UDM device, UDR device, etc.), access network device (e.g., base station, WLAN AP, WiFi access node, cable network access device), wireless device, mobile device, smartphone, subscriber device, desktop computer, printer, IPTV, laptop, tablets, network edge device, Access Point, wireless router, switch, WLAN controller, orchestration server, orchestrator, Gateway, AAA server, server, node and/or element or other device described in the present application.

Numerous additional variations on the methods and apparatus of the various embodiments described above will be apparent to those skilled in the art in view of the above description. Such variations are to be considered within the scope. Numerous additional embodiments, within the scope of the present invention, will be apparent to those of ordinary skill in the art in view of the above description and the claims which follow. Such variations are to be considered within the scope of the invention.

What is claimed is:

1. A communications method comprising:
storing a certificate corresponding to a user plane function (UPF) in the UPF of a network core;
operating the UPF to use the stored certificate corresponding to the UPF to establish a secure connection between a first user equipment (UE) and the UPF; and
operating an authentication server function (AUSF) included in the network core to perform an Extensible Authentication Protocol (EAP) authentication procedure to authenticate the first UE based on information communicated via the secure communication connection.

2. The method of claim 1, wherein using the stored certificate corresponding to the UPF to establish a secure connection involves communicating crypto key information as part of a handshake between the first UE and UPF.

3. The method of claim 1, further comprising:
operating the UPF to select a first session management function (SMF) in the network core to provide service to the first UE; and
operating the UPF to send a N4 Session message to the first SMF, said N4 session message includes a first UE NAI (Network Access Identifier) corresponding to the first UE and Protocol Data Unit (PDU) Session request related information.

4. The method of claim 3, further comprising:
operating the first SMF upon receiving a N4 Session message from the UPF, to retrieve UE subscription information from a unified data management (UDM) or a unified data repository (UDR) and initiate the authentication process;
operating the first SMF to send an authentication request including the first UE NAI to the AUSF in the network core;
operating the AUSF to retrieve UE credentials from the UDM or the UDR and to send authentication response to the first SMF; and
operating the first SMF to send N4 Session message to UPF with authentication challenge.

5. The method of claim 4,
wherein operating the AUSF to perform an EAP authentication procedure to authenticate the first UE, includes communicating a challenge to the first UE over the secure connection between the UPF to the UE, said challenge being from the AUSF.

6. The method of claim 4, further comprising:
operating the first SMF, following successful authentication of the first UE, to receive an indication of the successful authentication and optionally to initiate Session Management (SM) Policy Association Establishment or Modification with a first policy control function (PCF); and
operating the first SMF, following successful authentication of the first UE and optionally completing SM Policy Association Establishment or Modification with the first PCF, to communicate PDU session related information corresponding to the first UE to the UPF.

7. The method of claim 6, further comprising:
operating the UPF to communicate authentication success and PDU session related information to the first UE over the secure communications connection between the UPF and first UE; and
operating the first SMF to send UPF ID and SMF ID associated with first UE to the UDM or UDR for storage.

8. The method of claim 7, further comprising:
communicating application data over the secure communication connection between the first UE and UPF via a non-integrated non-3GPP access network.

9. The method of claim 8, further comprising:
operating the network core to perform a 3GPP registration and PDU Session establishment procedure with the first UE via a 3GPP access network; and
operating the first access and mobility management function (AMF) to retrieve the SMF ID, UPF ID that was stored in the UDM during the non-integrated non-3GPP procedures.

10. The method of claim 1, further comprising:
operating the first UE to perform a UE authentication procedure with the network core via the secure connection.

11. The method of claim 1, further comprising:
operating the first UE to obtain the Internet Protocol (IP) address of the UPF prior to operating the UPF to use the stored certificate to establish the secure communications connection between the first UE and UPF.

12. The method of claim 11, wherein the first UE is pre-provisioned with a UPF Fully Qualified Domain Name (FQDN) corresponding to a UPF which supports non-integrated non-3GPP access.

13. The method of claim 12, wherein operating the first UE to obtain the IP address of the UPF includes:
sending a query including the pre-provisioned UPF FQDN to a Domain Name Server (DNS); and
receiving a response from the DNS including the IP address of the UPF.

14. A communications system comprising:
a network core including:
a user plane function (UPF) including a first processor and a first memory; and an authentication server function (AUSF) including a second processor; and
wherein said first processor is configured to operate the UPF to:
store in said first memory a certificate corresponding to the user plane function (UPF) a certificate corresponding to the user plane function (UPF);
use the stored certificate corresponding to the UPF to establish a secure connection between a first user equipment (UE) and the UPF; and wherein said second processor is configured to operate the AUSF to:
perform an Extensible Authentication Protocol (EAP) authentication procedure to authenticate the first UE based on information communicated via the secure communication connection.

15. The communications system of claim 14, wherein said first processor is configured to operate the UPF to communicate crypto key information as part of a handshake between the first UE and UPF, as part of being configured to operate the UPF to use the stored certificate corresponding to the UPF to establish a secure connection.

16. The communications system of claim 14, wherein said first processor is further configured to:
operate the UPF to select a first session management function (SMF) in the network core to provide service to the first UE; and
operate the UPF to send a N4 Session message to the first SMF, said N4 session message includes a first UE NAI (Network Access Identifier) corresponding to the first UE and Protocol Data Unit (PDU) Session request related information.

17. The communications system of claim 16, wherein said network core further includes said first SMF including a third processor configured to:
operate the first SMF to receive a N4 Session message from the UPF;
operate the first SMF, upon receiving a N4 Session message from the UPF, to retrieve UE subscription information from a unified data management (UDM) or a unified data repository (UDR) and initiate the authentication process; and
operate the first SMF to send an authentication request including the first UE NAI to the AUSF in the network core; and
wherein said second processor is further configured to:
operate the AUSF to retrieve UE credentials from the UDM or the UDR and to send authentication response to the first SMF; and wherein said third processor is further configured to:
operate the first SMF to send N4 Session message to UPF with authentication challenge.

18. The communications system of claim 17, wherein said second processor is configured to:
operate the AUSF to communicate a challenge to be sent to the first UE over the secure connection between the UPF to the UE, as part of being configured to operate the AUSF to perform an EAP authentication procedure to authenticate the first UE, said challenge being from the AUSF.

19. The communications system of claim 17, wherein said third processor is further configured to:
operate the first SMF, following successful authentication of the first UE, to receive an indication of the successful authentication and optionally to initiate Session Management (SM) Policy Association Establishment or Modification with a first policy control function (PCF); and
operate the first SMF, following successful authentication of the first UE and optionally completing SM Policy Association Establishment or Modification with the first PCF, to communicate PDU session related information corresponding to the first UE to the UPF.

20. The communications system of claim 19,
wherein said first processor is further configured to:
operate the UPF to communicate authentication success and PDU session related information to the first UE over the secure communications connection between the UPF and first UE; and
wherein said third processor is further configured to:
operate the first SMF to send UPF ID and SMF ID associated with first UE to the UDM or UDR for storage.
